(19) United States
(12) Patent Application Publication
(10) Pub. No.: US 2010/0196637 A1
(43) Pub. Date: Aug. 5, 2010

(54) METHOD FOR PRODUCING FIBRE-REINFORCED HOLLOW BODIES AND PRODUCTS FORMED USING SAID METHOD

(75) Inventors: Thomas Lippert, Augsburg (DE); Helmut Michel, Esslingen (DE); Ulrich Strasser, Gersthofen (DE)

Correspondence Address: ROTHWELL, FIGG, ERNST & MANBECK, P.C., 1425 K STREET, N.W., SUITE 800, WASHINGTON, DC, 20005, US

(73) Assignee: MT AEROSPACE AG, Augsburg (DE)

(21) Appl. No.: 12/594,407

(22) PCT Filed: Mar. 26, 2008
(86) PCT No.: PCT/EP08/02380

§ 371 Date: Apr. 19, 2010

(30) Foreign Application Priority Data
Apr. 2, 2007 (DE) 10 2007 015 909.0

(51) Int. Cl. B29C 70/22; B32B 37/22

(52) U.S. Cl. 428/36.1; 156/182; 156/87

(57) ABSTRACT

The invention relates to a method for producing fibre-reinforced hollow bodies comprising integrally formed elements in a hollow mould. A fibre mat is laminated in two halves of the hollow mould, which respectively form the negative mould for the fibre-reinforced hollow bodies comprising integrally formed elements to be produced, and, once the two halves of the thus lined hollow mould have been connected, the fibre mat is pressed into the hollow mould under pressure in a form-fitting manner. The invention also relates to products produced according to the inventive method.

This application is a 35 U.S.C. 371 National Phase Entry Application from PCT/EP2008/002380, filed Mar. 26, 2008, which claims the benefit of German Patent Application No. 10 2007 015 090.0 filed on Apr. 2, 2007, the disclosure of which is incorporated herein in its entirety by reference.

The present invention relates to a method for the production of fibre-reinforced hollow bodies with elements integrally incorporated onto the hollow body such as connection brackets, suspension brackets, flanges, fins and similar elements, and the products thus created.

Fibre-reinforced hollow bodies with connection brackets, suspension brackets, flanges, fins and similar elements can only be produced with very time-consuming technologies. Numerous procedures have been described by the state of the art of technology.

For example U.S. Pat. No. 4,963,301 describes a process for the production of a strut with end brackets. This strut consists of three components: a tubular hollow body and two bracket heads with a smaller diameter inserted at both ends of the hollow body. It is produced by using a pre-impregnated fibre material that is rolled onto a core tube and subsequently cured. Thereafter the cured fibre material can be converted by pyrolysis and densified by infiltration. Through repeated application of pyrolysis and infiltration, a fire-resistant strut is created. The bracket heads are either moulded on or inserted subsequently, or a core tube tapered towards one side is used for the rolling-on process. With this method it is thus not possible to produce a one piece fibre-reinforced hollow body free of creases.

According to the German Patent 31 13 791, struts are produced using a hard rod-shaped core which is covered by a rubber hose. Around the hose, several layers of fibre material pre-impregnated with resin are wrapped in overlapping fashion. The inner core thus prepared is placed into a segmented hollow mould with four recesses. After the hollow mould halves have been firmly locked, the hose pinched close on one side is inflated so that the fibre material is pressed against the inner wall of the hollow mould and the hard core can be pulled out via the hose's open end. Subsequently, 4 mould bodies are inserted into four recesses of the hollow mould for forming the transition and end sections (brackets). The resin is cured in the oven or autoclave, depending on the resin system at, for example, 125 C. or 175 C. and under controlled inner hose pressure. Once the curing is completed, the hose is pulled from the strut at one of the open bracket ends and the bracket section is machined. No gluing of cured components is required since the curing is done according to the one shot curing method.

The brackets are each fitted with one bore, into which one bushing is pressed or glued for better load distribution. In order to prevent any abrasion, the bushings are fitted with a collar protruding from the surface of the bracket.

This method has the disadvantage that in order to shape the transition and end sections, the placed fibre compound is squeezed from a circular into a rectangular shape and thus tends to suffer distortions and fibre dislocations in those sections. Furthermore, it is in general extremely difficult to expand fibre compounds that are wrapped in several layers around core tubes in an even fashion by inflating the hose. Own experiments showed unsatisfying results.

The above methods are but a few examples for the basic known techniques. They all share the disadvantage that these methods deliver inconsistent products. This also compromises the quality of the fibre-reinforced hollow bodies, in particular in the bracket section which is under high stress from external loads. The reject rate is accordingly high. Furthermore, the equipment used and its handling is relatively costly and time-consuming.

In particular, the purpose of the present invention is to specify a method for producing thin-walled tubular or prism-shaped hollow bodies with integrally incorporated elements allowing to avoid the disadvantages of the known state of the art methods. In particular it is designed to enable the production of fibre-reinforced hollow bodies with integrally incorporated elements in a consistently reproducible fashion, where the required stability and quality specifications of the hollow bodies in all their production stages up to the final form are ensured. It is of great interest to join thus produced hollow bodies via integrally incorporated elements, for example ribs or ridges, into surface-like structural components such as shields, panels and similar elements and cure them all together. In order to lock the larger hollow mould halves required for this purpose, the higher counter pressure forces required from outside can be applied via suitably positioned bolts. Suitable for this are also temperature-resistant devices such as pressure pads, hold-downs, in particular hydraulically or pneumatically controlled power devices and/or pressure sleeves that apply outer pressure onto the hollow mould and are located between the mould and the ceiling or cross bars. Furthermore, the vacuum pack principle can be used alone or combined by packing the hollow mould into an impermeable flexible jacket and evacuating this jacket in order to allow the surrounding pressure to show effect. Instead of the jacket, also known as vacuum bag, even an impermeable flexible plastic sheet can be used that is sealed around the edge towards the base plate and/or the moulding tool.

Object of the present invention, therefore, is a method for the production of fibre-reinforced hollow bodies with integrally incorporated elements in a hollow mould, where a fibre mat is laminated into two halves of the hollow mould, which each form a negative mould for the fibre-reinforced hollow body with integrally incorporated elements to be produced, and after the two halves of the lined hollow mould are joined, the fibre mat is pressed against the inner wall of the hollow mould simultaneously curing and forming the fibre-reinforced hollow body with integrally incorporated elements.

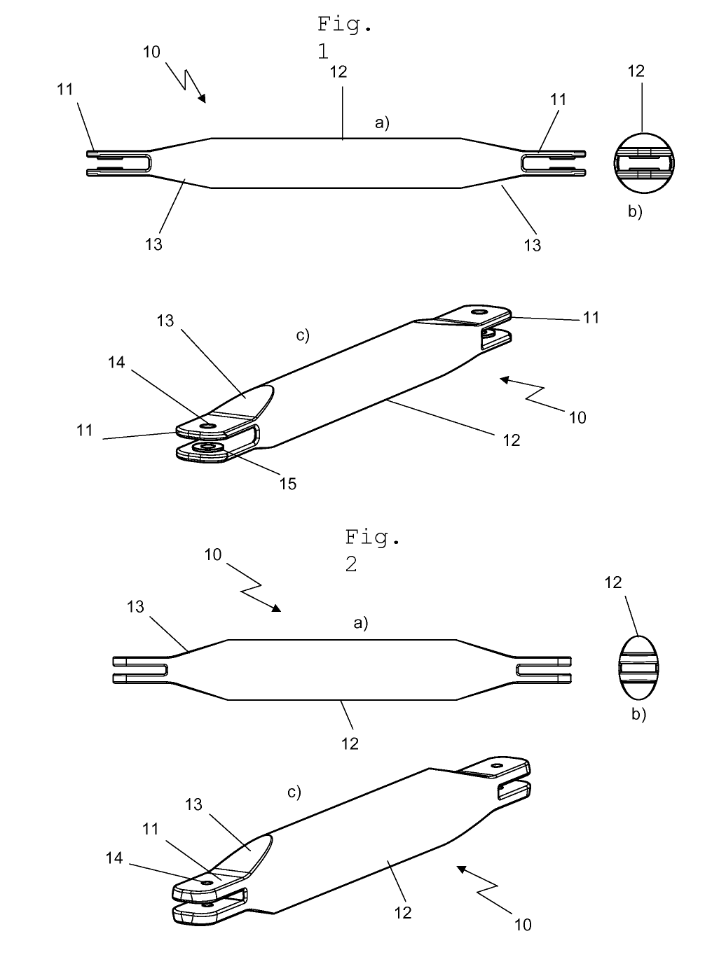

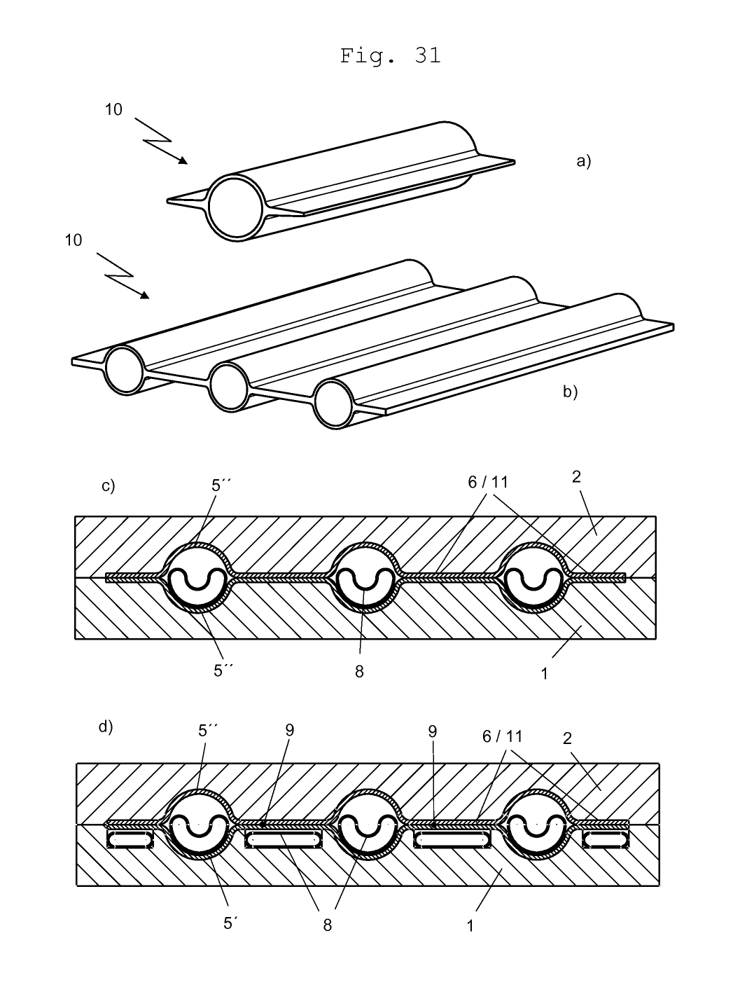

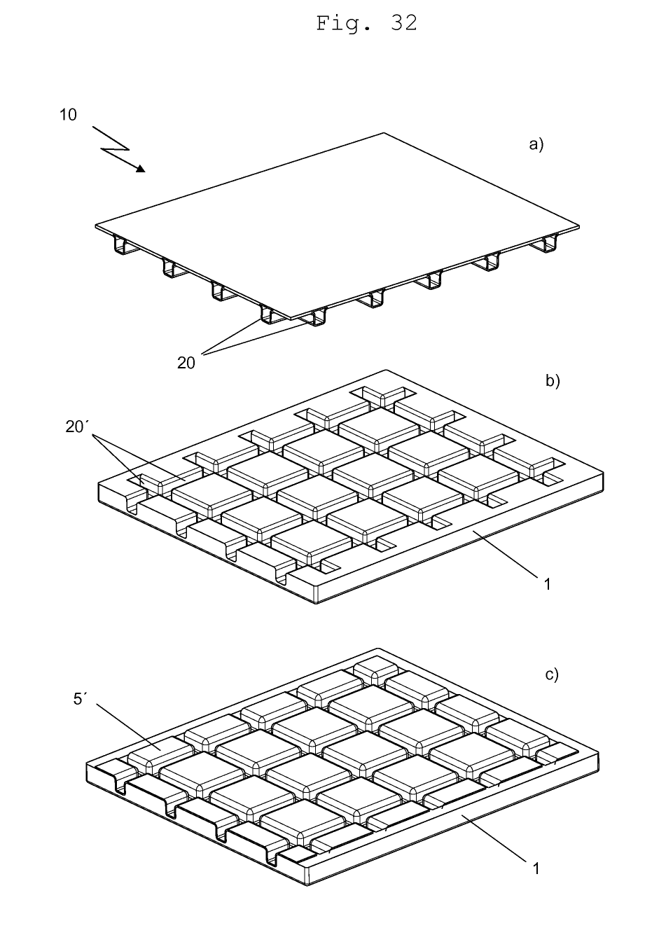

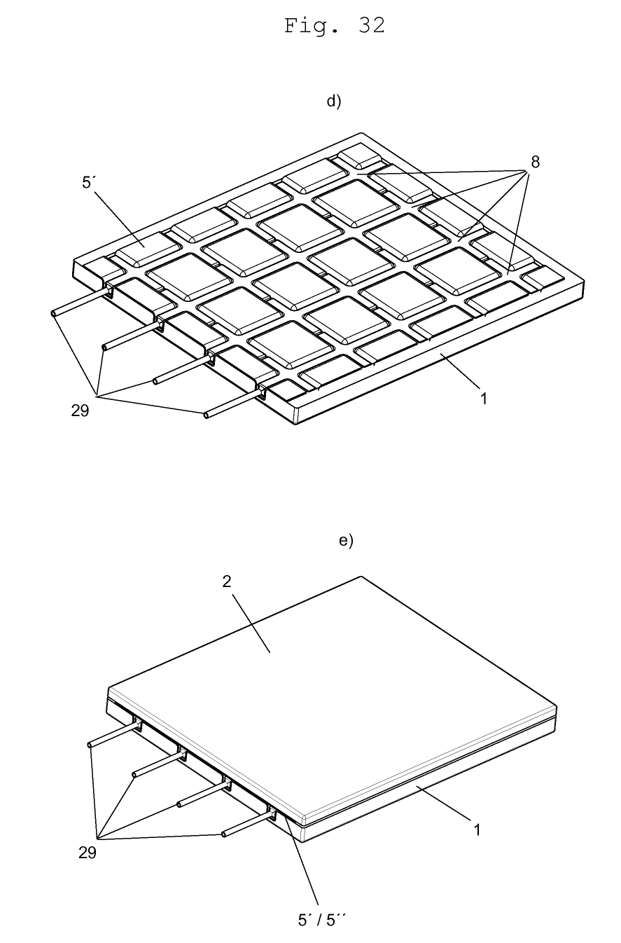

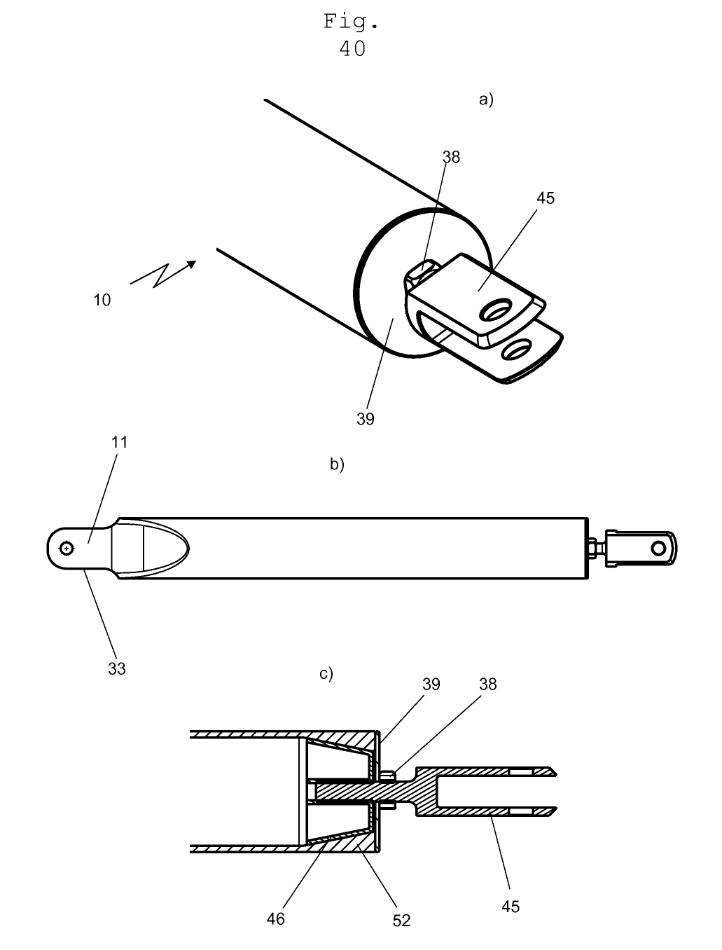

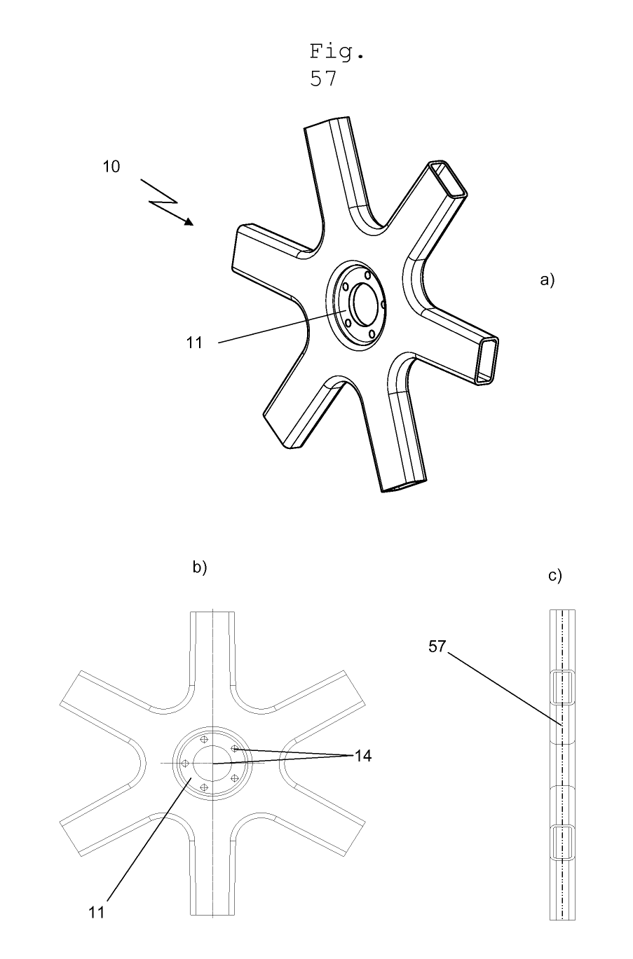

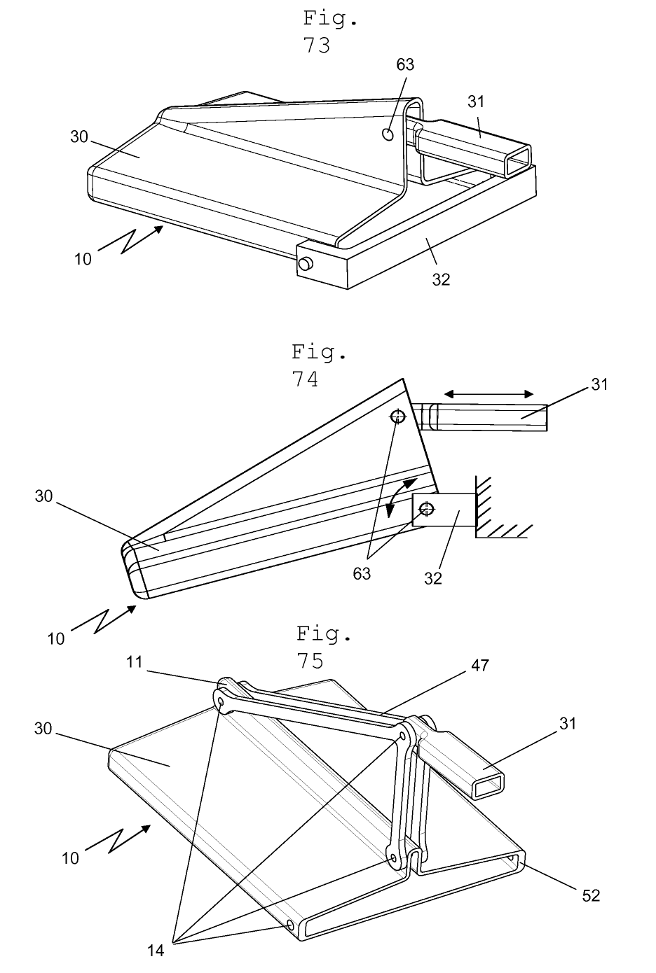

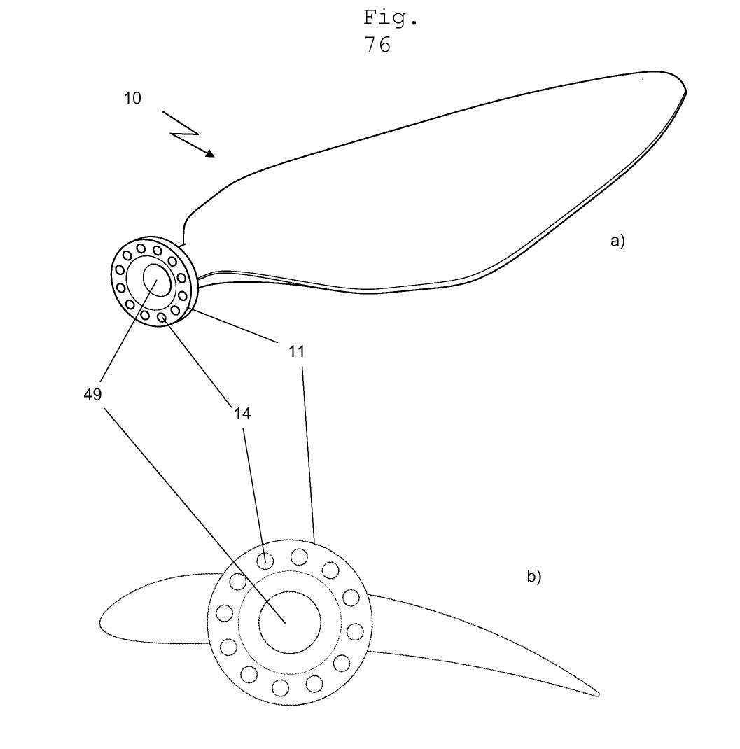

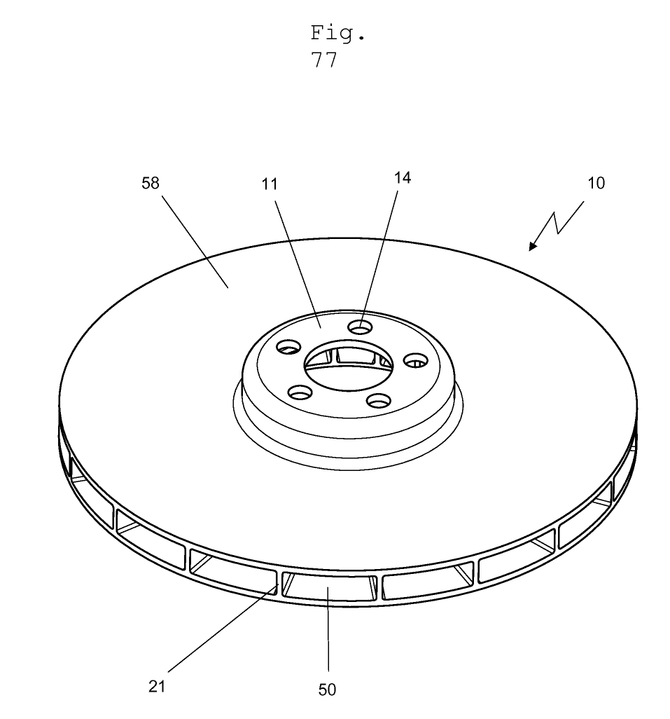

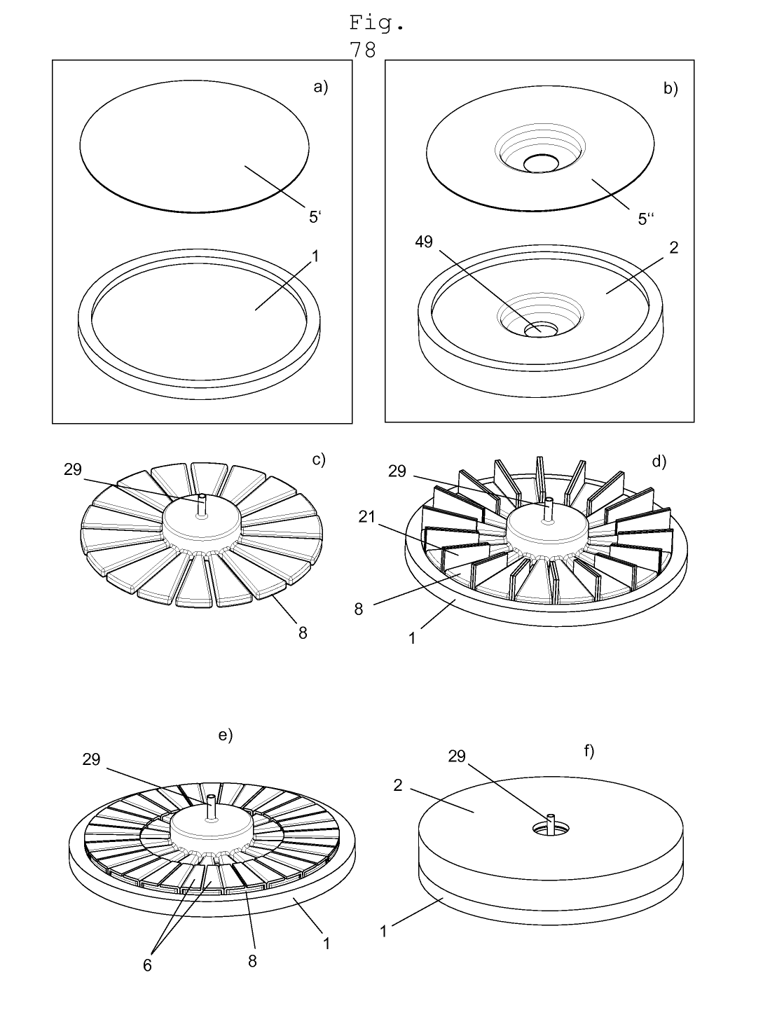

It is obvious that for pressing the fibre mats against the inner wall of the hollow mould pressure is applied, and that for curing a resin system soaked up by the fibre mats the effect of (preferably) heat is required. These fibre-reinforced hollow bodies are specifically bodies with a tubular or prism-shaped outer shape; however also many other cross-sectional designs are possible, as will be discussed later from case to case. This invention allows the advantageous production of fibre-reinforced hollow bodies with low porosity and high fibre volume ratio using at least one inflatable hose and/or balloon in a hollow mould lined with specially pre-treated dry textile semifinished fibre products and/or with impregnated semifinished fibre products (prepregs), in particular such featuring a tubular and/or prism-shaped design with integrated brackets, fins, flanges and similar elements. This includes struts required for structural designs, for example in the aerospace or automotive industry (FIGS. 1 to 5, FIGS. 34 to 40), tubes with suspension brackets or flanges (FIGS. 27 to 30), finned tubes (FIG. 31), structural components for aircraft seats (FIGS. 41, 43, 45, 50 to 54), fork struts, for example for the extension/retraction mechanism of aircraft landing gear (FIG. 55), spoke bodies (FIGS. 56 to 61), control flaps, for example for re-entry vehicles in space flight (FIGS. 64, 66 to 75), blades, for example for wind power plants (FIG. 76), brake discs (FIGS. 77 and 78), the inlet front lip of aircraft gas turbines (FIGS. 79 to 84), fuselage segments of aircraft (FIG. 32, 85, 92, 93, 95, 96) and similar. These components can cover a wide thermo-mechanical range of applications, in particular, since—depending on their field of application—they can consist of various materials such as fibre-reinforced plastic or ceramic matrix composites (CMC) and can as such be designed both for normal as well as very low or very high temperatures.

For the purpose of the present invention, the term fibre mat shall comprise all pre-impregnated and/or pre-treated fibre plies or semifinished fibre products respectively, which after lining the hollow mould can also be referred to as laminate. This also includes dry textile semifinished fibre products that have been prepared against any unwanted shifting as they are placed into hollow moulds for example by so-called preforming.

The required hollow mould is designed, as a negative of the fibre-reinforced hollow body to be produced, mostly of two parts and can be vented and locked. It is made preferably of a strong material with high thermal conductivity. When partly impregnated originally dry textile semifinished fibre products are used that will only be injected with resin once they are in the hollow mould, then the second mould half may also consist of flexible materials such as, for example, vacuum plastic sheet.

Compared to metal designs, fibre-reinforced hollow bodies are lighter and have at least equal strength and stiffness characteristics with regard to pressure, tension, bending and torsion. Furthermore, they have a better damping capacity. Fibre-reinforced hollow bodies with, for example, integrated connection brackets have weight and strength benefits compared to those with inserted bracket heads, as in the joint area (bonding) grooves and double layers are unavoidable. The same applies for fibre-reinforced tubes with flanges and many other fibre-reinforced hollow bodies.

Although the method in accordance with the invention uses similar process steps as used in the state of the art technology, it nevertheless presents a significant improvement and simplification to the currently known methods. Firstly, no previously described hard core is required, and, secondly, the fibre composite is placed into all hollow body sections, especially into the transition and end section (bracket), in direction of the force flow enabling it to better cope with the load. In the highly stressed end section (bracket), the fibre is placed in isotropic fashion. For this purpose, suitable hollow mould halves (negative moulds) are used. This eliminates the squeezing of the fibre layers by means of mouldings, which alters the cross-sectional shape including all disadvantages connected with this approach. Therefore, the transition sections no longer need to be squeezed into shape from circular to rectangular profile, generally speaking from large to small cross-sections, since the prepreg material is placed free of creases and in stable position directly into two open negative moulds complementing each other. In principle, this means that less production steps are required, which translates into less time involved and less risk of rejects. Additionally, the hollow mould has a simpler design and the current risk for the blank inherent in the process is mostly eliminated.

Preferred embodiments are detailed in the subclaims.

For example, the fibre mat is preferably a fibre ply impregnated with resin or a fibre prepreg. The fibre ply can also be only partly impregnated with resin.

The fibre mat is preferably pressed against the inner wall of the hollow mould by means of an inflatable element inserted into the hollow mould that is inflated after the two halves of the hollow mould have been joined. The joining of the mould halves can also be achieved, for example, using the surrounding pressure (atmosphere, autoclave) by means of a vacuum bag.

Preferably the fibre mat(s) is/are placed into the hollow mould halves according to a defined load specificity of various sections of the hollow body. This is achieved by placing the fibre mat(s) into the hollow mould halves in such an alignment that they can absorb the specified loads in the composite in an optimised fashion.

On top of the fibre mat(s), the invention envisages to optionally place a ventilation fabric, i.e., venting fabric. Also underneath the fibre mat(s) a venting fabric can be placed. In between a semi-permeable sheet can be placed if the resin is infiltrated via vacuum.

In a particular embodiment of the present invention, the fibre mat(s) and, if applicable, the venting fabric are placed into one half each of the hollow mould in such a way that they protrude by a specific level over at least one upper edge of the relevant hollow mould half.

According to the invention, the protruding sections of the fibre mat and, if applicable, the venting fabric prior to joining the hollow mould half can be fanned out in such a way that both fanned out sections are fitting into each other once the halves are joined.

For the formation of the material sections protruding above the upper edge of the hollow mould halves, if required, a shoulder is positioned next to the hollow mould halves at least on one side which will support the protruding material sections during lamination. Additional metal rails may be positioned next to the shoulders assisting the fanning-out of the laminate layers and/or facilitating the desired positioning of the protruding material sections prior to joining the hollow moulds.

The fibre ply present in the hollow mould is evacuated, if required, and additionally infiltrated with resin, if applicable. The fibre ply present in the hollow mould may also be exposed to an additional pressure and temperature treatment.

The cured hollow body blank thus obtained undergoes preferably a mechanical finishing process, for example contour machining, and can additionally be physically and/or chemically densified.

The fibres in the inserted fibre mats are aligned in unidirectional, crosswise, multiaxial and/or cross-over fashion and preferably fixed in a thermoplastic or duroplastic matrix material.

The fibres selected for material reinforcement are preferably selected from carbon, glass, polyester, polyethylene and nylon fibres.

The used fibres are selected from inorganic fibres, if a fire-resistant, chemically densified hollow body should be created. This includes carbon. The fibres or filaments are then selected from carbon, silicon carbide, aluminium oxide, mullite, boron, wolfram, boron carbide, boron nitride and zirconium fibres. Both same-sort and mixed-sort fibres can be used.

The outer shape of the fibre-reinforced hollow body to be produced is not particularly limited by the method in accordance with the invention. This means that fibre-reinforced hollow bodies with essentially circular, oval, square or rectangular cross-section can be produced with or without inner ribs, provided the cavity shape and/or the cavity halves are designed accordingly. The method is equally suited for producing struts, tubes, so-called finned tubes as well as box-shaped structures such as, for example, control flaps or fuselage segments reinforced by transversal and longitudinal profiles.

The lamination is done preferably with preprag fibre material. In the tube/prism section, for example a strut with brackets, for example 60% of the fibre material is placed parallel to the longitudinal axis (0° direction) and 40% is placed at ±45° (also referred to as +/−direction). In the end sections (brackets) approximately one third of the fibres are arranged parallel to the longitudinal axis. Another 30% is arranged perpendicular to it (90° direction) and the rest at less than ±45° to the longitudinal axis. In the ramp-shaped transition section between bracket and tube/prism section, the reinforcing fibres are placed in gradual stages.

The semifinished fibre products are available in unidirectional, crosswise, multiaxial but also cross-over in various ways interwoven or braided design. Some of the suppliers include companies such as Cytec, Hexcel, ICI, Interglas, Kramer and Saertex.

Uncured matrix material is commercially available in both thermoplastic and duroplastic characteristics by companies such as Cytec, Hexel, ACG, Huntsman.

If required, the lamination can be done in mixed fashion, i.e. unidirectional semifinished fibre product layers can be followed by crosswise interwoven fibre layers. This may be beneficial in the bracket bore section, depending on the specified load.

For cost reasons or due to lower requirements for the stiffness of the fibre-reinforced hollow body, other fibre materials may be used instead of carbon fibres, both as same-sort and mixed-sort fibres. A fibre-reinforced plastic strut made of a combination of, for example, glass and carbon fibres will be more flexible and economic than one reinforced exclusively by carbon fibres. Apart from glass and carbon fibre semifinished products, there are other fibre materials that can be used for fibre-reinforced hollow bodies. They are known to the expert for application in various temperature ranges.

If, for fibre-reinforced hollow bodies or their pre-fixed, partially or fully cured fibre preform in near net shape a resin matrix is converted by pyrolysis and densified by further infiltration of resinous material (polymer infiltration) and subsequent pyrolysis, generally inorganic fibre materials including ceramic filaments such as carbon, graphite, glass and aramid will be used. As ceramic filament materials, carbon, silicon carbide, aluminium oxide, silicon nitride, mullite, boron, wolfram, boron carbide, boron nitride, zirconium and others are used. Ceramic fibres are high-temperature resistant. The CMC (Ceramic Matrix Composites) units produced with this Liquid Polymer Infiltration (LPI) method generally undergo 5 to 8 pyrolyses and are suitable for components that resist medium-level mechanical and thermal loads.

For CMC material exposed to high thermo-mechanical stress, matrix material can be deposited onto the fibre surfaces during gas phase via the Chemical Vapour Infiltration (CVI) method. With this method, under specific pressure and temperature conditions, matrix material is deposited on and in between the fibres of the near net shape unit even in the interior of the unit until the surface of the component is fully covered by matrix material. In this way, for example carbon fibres can be embedded into a silicon carbide matrix, silicon carbide fibres into a silicon carbide matrix or a silicon nitride matrix, aluminium oxide fibres into an aluminium oxide matrix, or mullite fibres into a mullite ceramic.

Subsequently, the present invention is explained in detail by application examples, notes regarding the production process and the hollow mould used by means of drawings. These show:

FIG. 1 a fibre-reinforced hollow body produced in accordance with the invention with fork/slot-shaped connection brackets and circular tube shaped centre section
a) in side view,
b) in front view, and
c) in perspective representation;

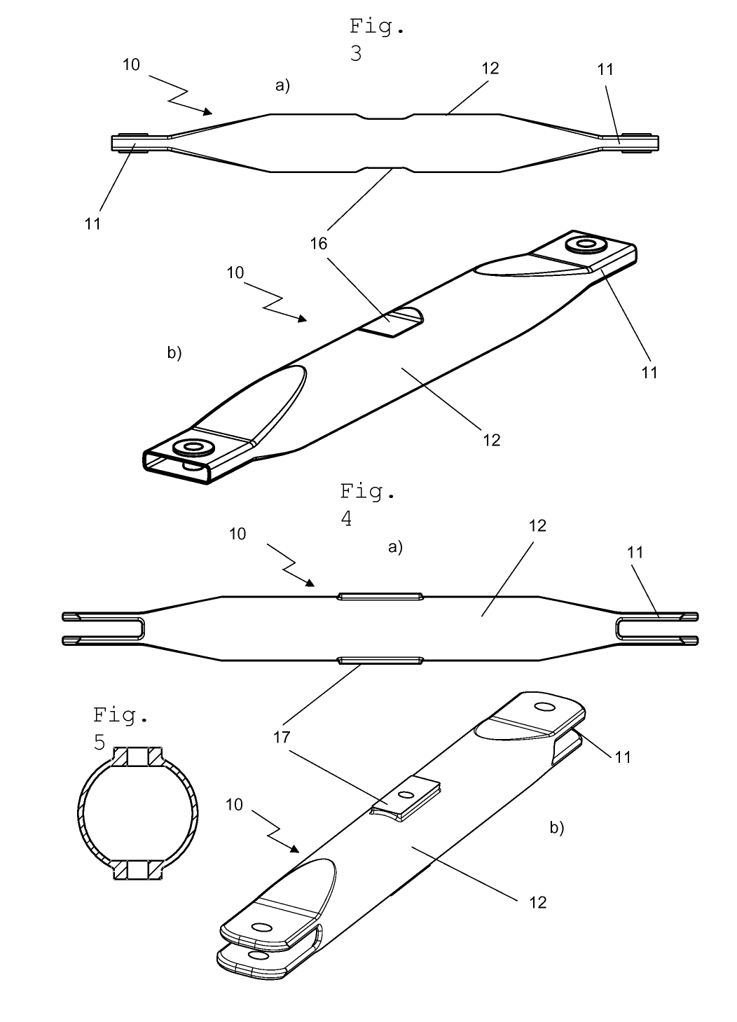

FIG. 2 another fibre-reinforced hollow body produced in accordance with the invention as in FIG. 1, but with oval cross-section in the middle part
a) in side view,
b) in front view, and
c) in perspective representation;

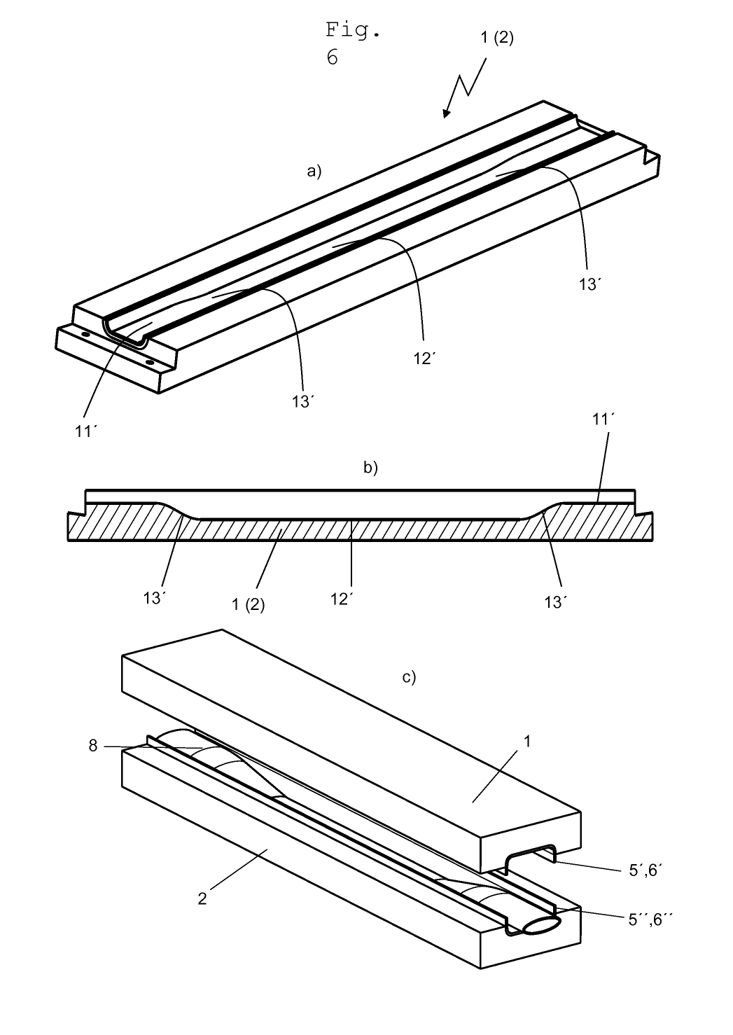

FIGS. 3 and 4 a fibre-reinforced hollow body produced in accordance with the invention as in FIG. 1 or 2 with even surfaces in the middle part, each in
a) side view, and
b) perspective representation;

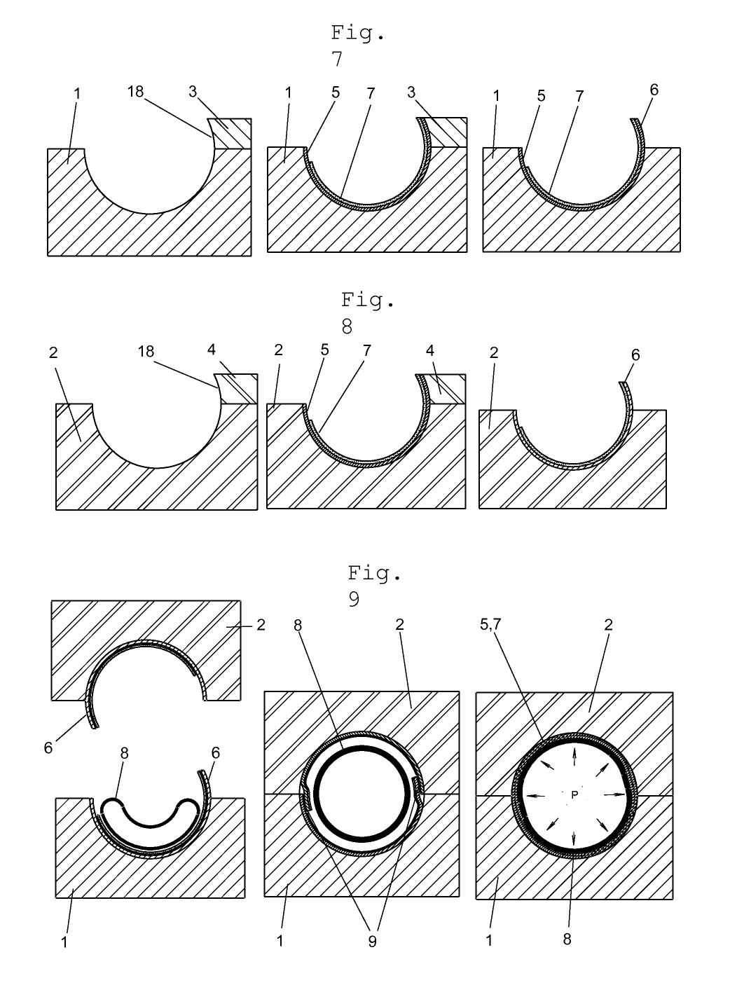

FIG. 5 a sectional representation of the hollow body as in FIG. 4;

FIG. 6 a hollow mould half designed in accordance with the invention for struts with integrated brackets
a) in perspective representation,
b) in sectional representation, and
c) shortly before joining both mould halves fitted with fibre material and hose;

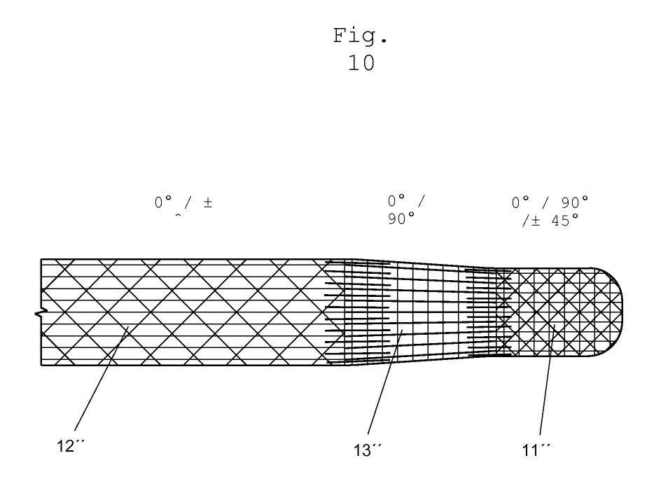

FIGS. 7 to 9 the procedure of the production method in accordance with the invention in a device of preferential design for tube/prism-shaped hollow bodies in cross-sectional representation;

FIG. 10 a placement pattern selected as an example in accordance with the invention for laminate layers of semifinished fibre products;

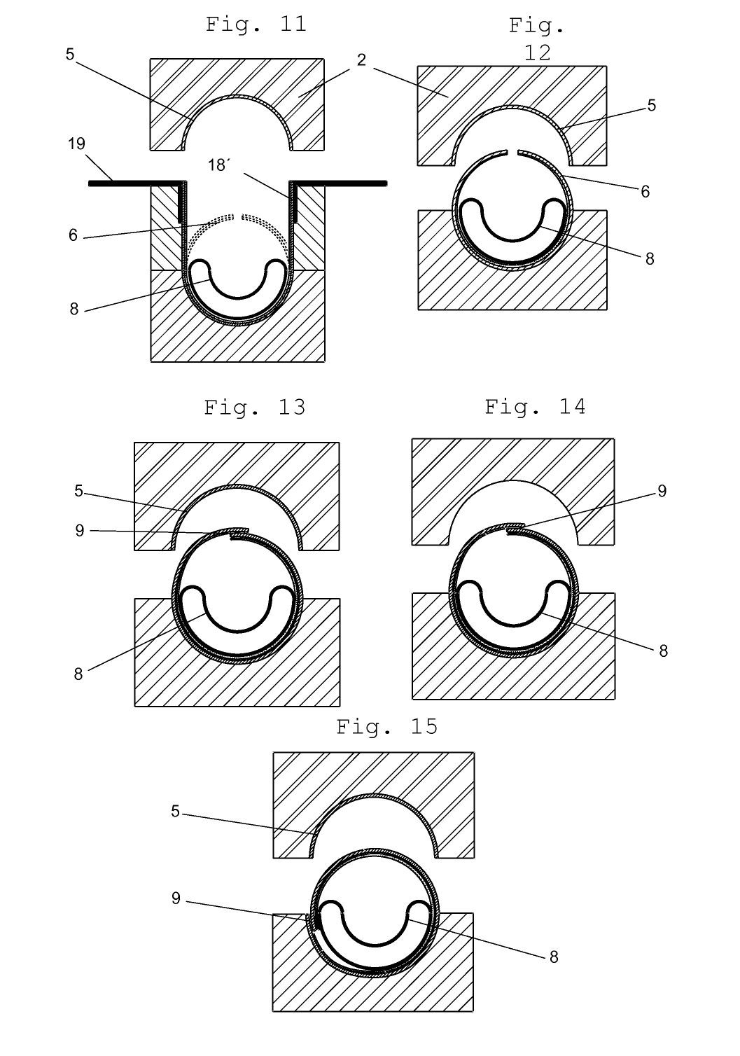

FIG. 11 a placement with high protrusions above the edge;

FIG. 12 with L-rails positioned edge strips free of creases shortly before joining and closing the mould halves;

FIG. 13 protruding edge strips for a placement provided with overlap on the upper laminate layer;

FIGS. 14 to 17 other possible approaches for joining laminate layers:

FIG. 14 without upper laminate layer,

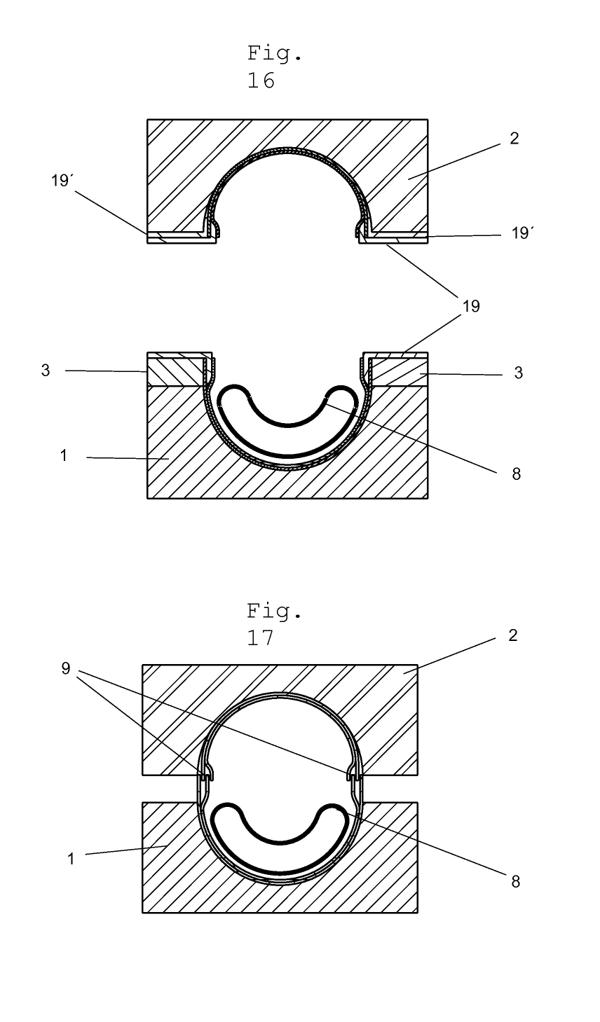

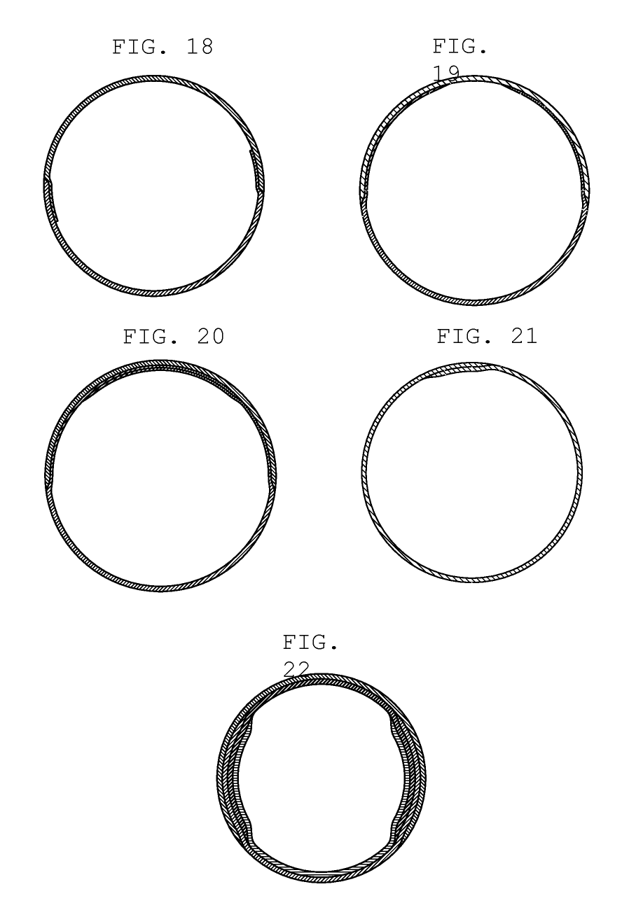

FIG. 15 with upper laminate layer.

FIGS. 16 and 17 with fanning of laminate layers;

FIGS. 18 to 22 each results of the approaches according to the corresponding FIGS. 9, 12, 13, 14 and 17 in cross-sectional representation;

FIGS. 23 to 26 embodiments with inner ribs in the hollow body cross section;

FIG. 27 a fibre-reinforced hollow body with suspension brackets integrated into the tube mantle
a) in side view,
b) in perspective view, and
c) the sectional representation of a possible mould design with placement example;

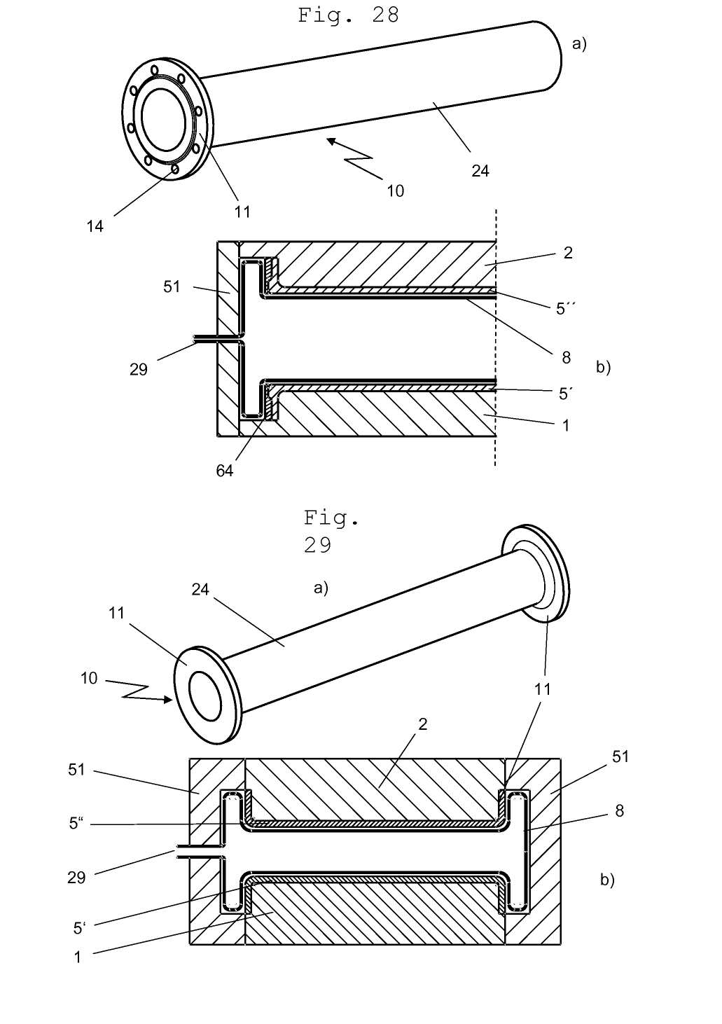

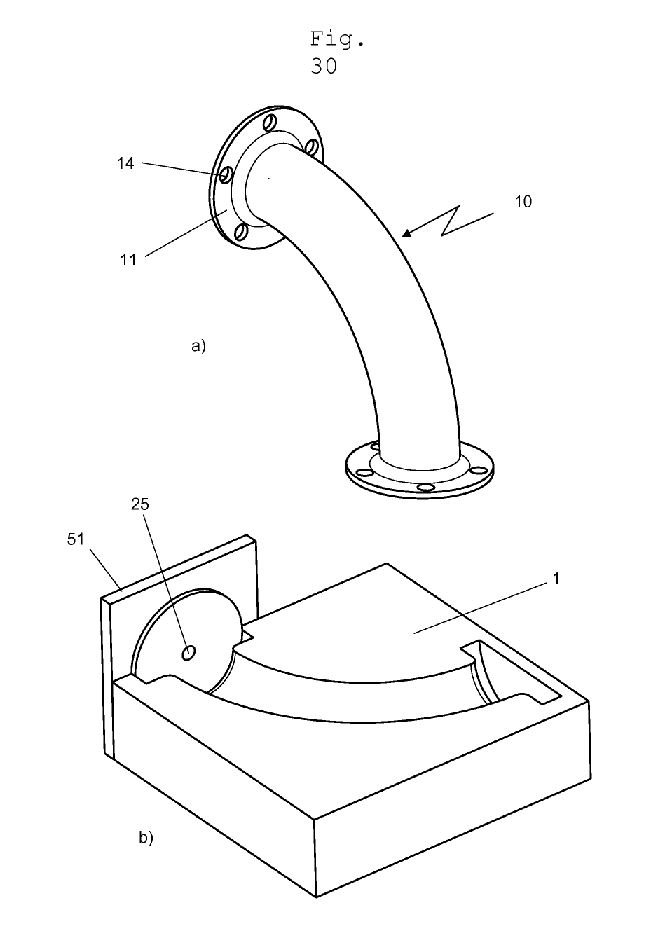

FIGS. 28 and 29 a hollow body with incorporated flanges, each
a) in perspective view, and
b) the sectional representation of a possible mould design with placement example;

FIG. 30 a hollow body curved in space (pipe bend) with integrally incorporated flanges
a) in perspective view, and
b) a hollow mould half pertaining to it;

FIG. 31 a fibre-reinforced hollow body
a) with laterally incorporated fins,
b) in form of a finned tube wall,
c) in cross-sectional representation including mould structure for production of the finned tube wall,
d) as in c) but with controllable pressing of fin bridges;

FIG. 32 a fibre-reinforced hollow body with large surface (reinforced plate) with integrally incorporated longitudinal and transversal bracing (strengthening)
a) in perspective view,
b) the hollow mould required for production,
c) the hollow mould laid out with laminate,
d) mould hoses/balloons in fully laminated hollow form, and
e) plane laminate with cover plate on hollow mould fitted with laminate and mould hoses;

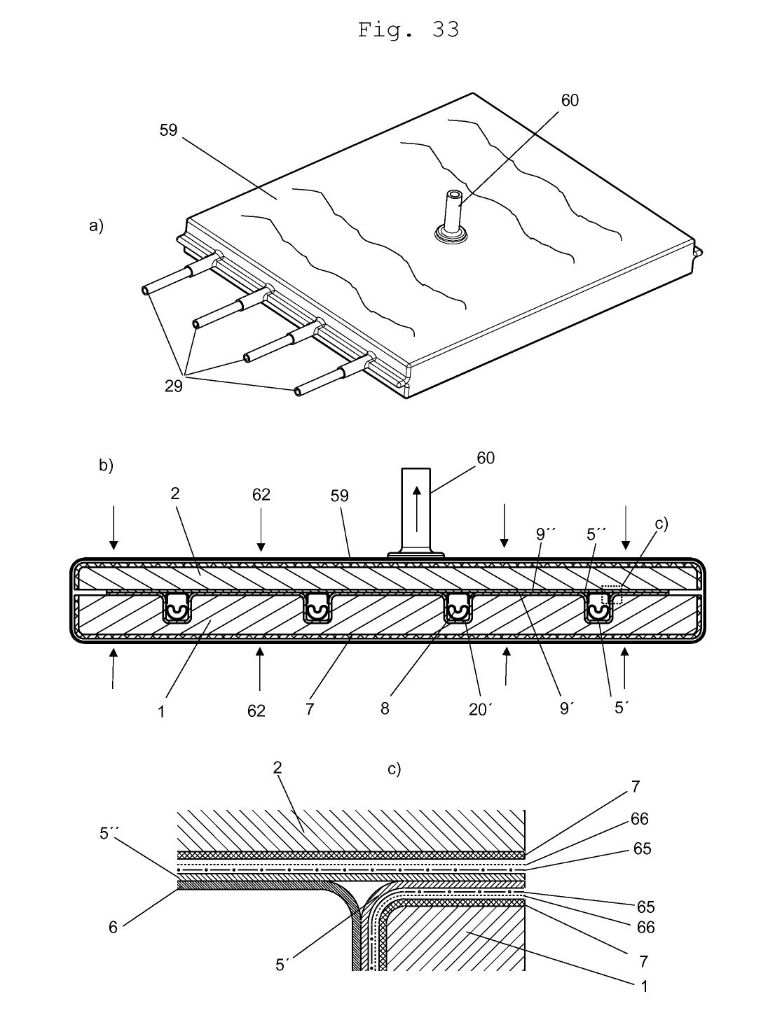

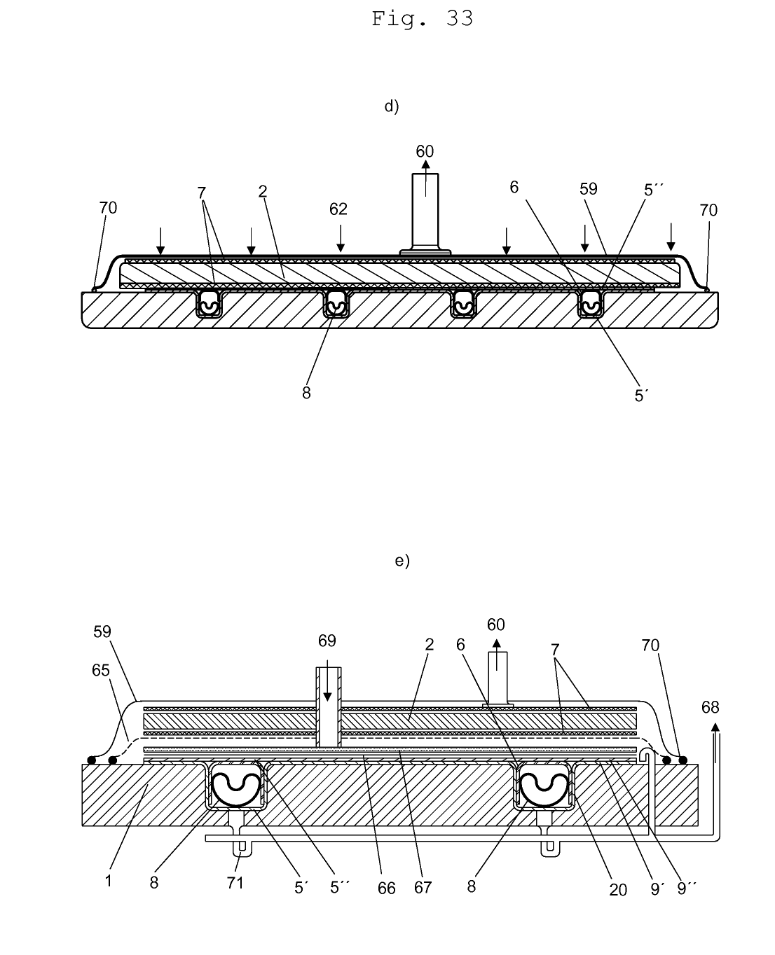

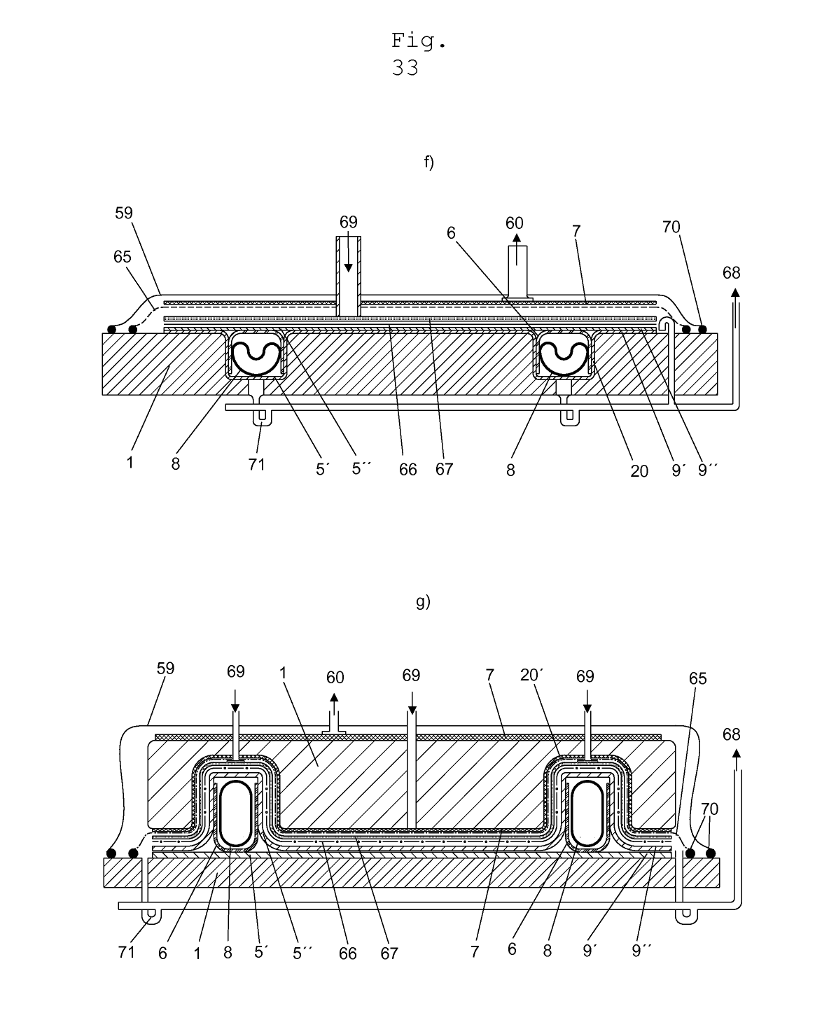

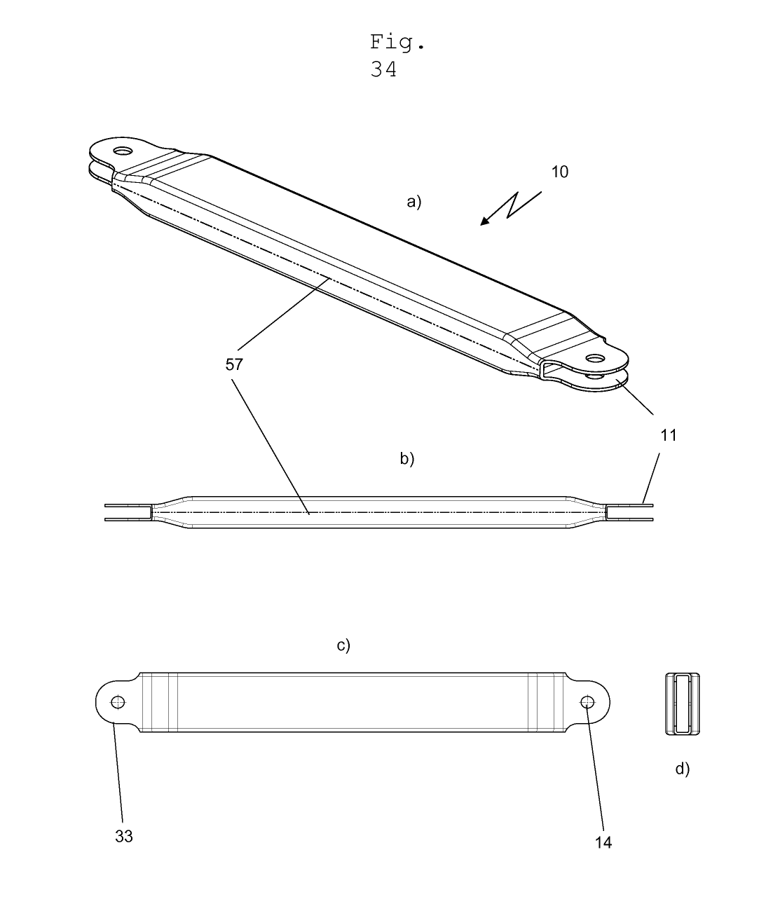

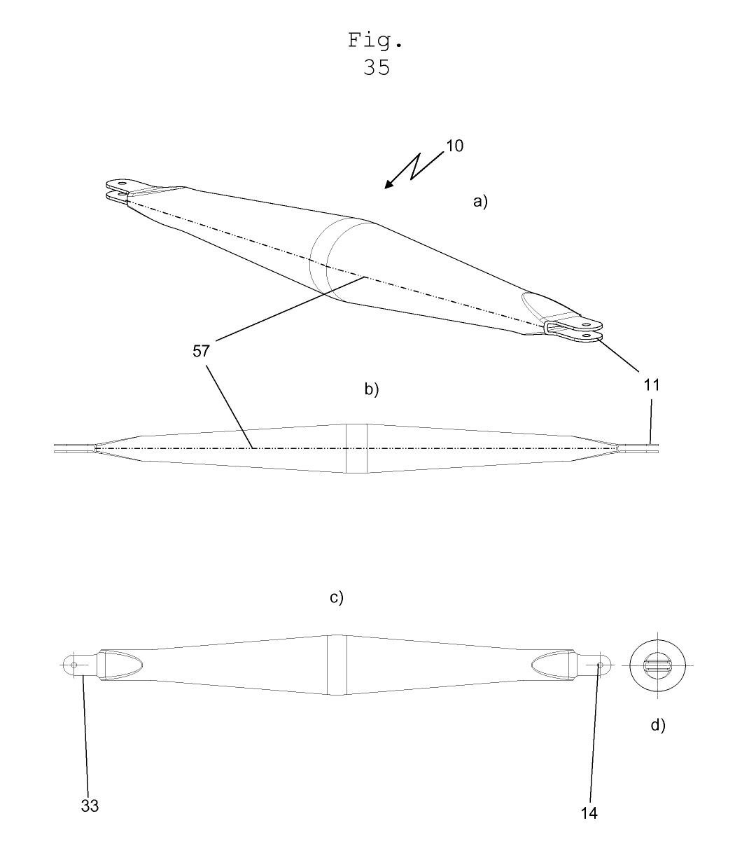

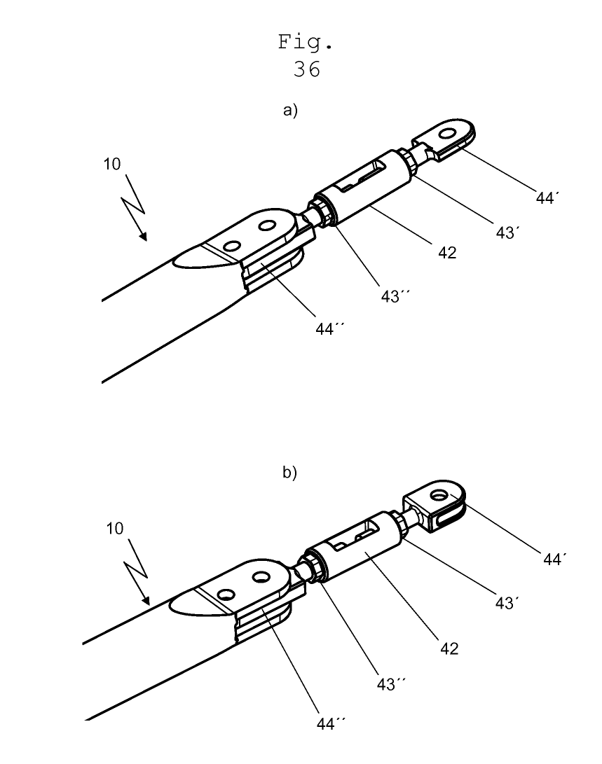

FIG. 33 the mould structure similar to FIG. 32 e) covered by venting fabric, inside a vacuum bag or a sheet for evacuation
a) in perspective representation,
b) in sectional representation,
c) detail from FIG. 33 b),
d) the mould structure similar to FIG. 33 a) but with a sheet sealed towards the lower hollow mould,
e) a mould structure with two spaces for separate evacuation (vent space and resin injection space),
f) a mould structure similar to FIG. 33 e) but with a flexible upper mould half,
g) the mould structure similar to FIG. 33 f) but with the plane panel surface on top of the lower mould half;

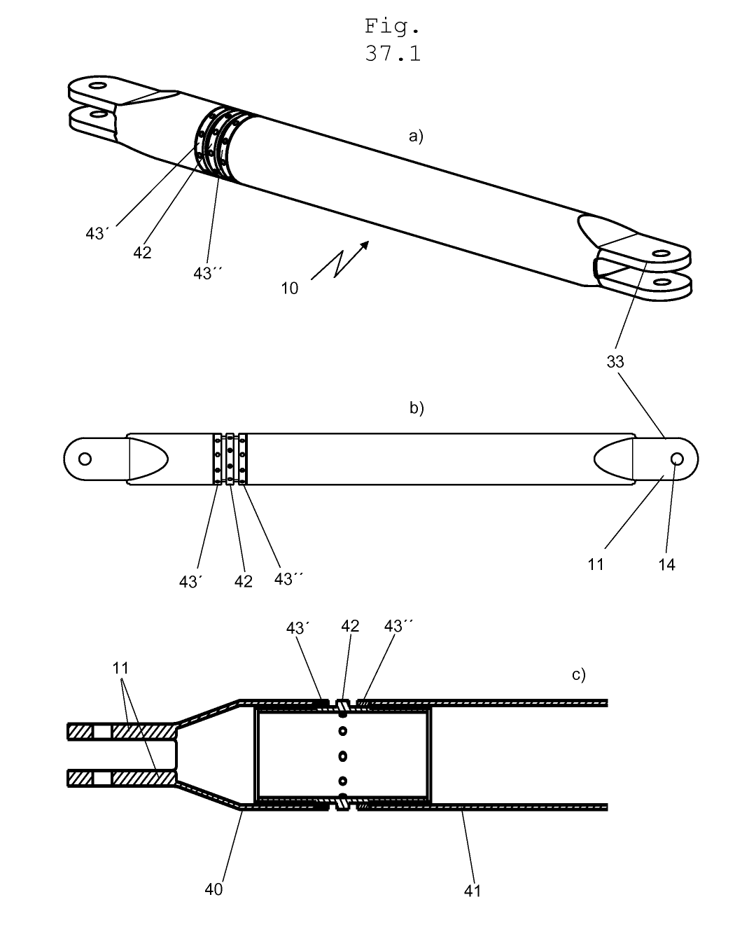

FIG. 34 a strut with fork-shaped brackets and rectangular cross-section
a) in perspective representation,
b) in side view,
c) in top view,
d) in front view;

FIG. 35 a strut with increasing cross-section toward the centre
a) in perspective representation,
b) in side view,
c) in top view,
d) in front view;

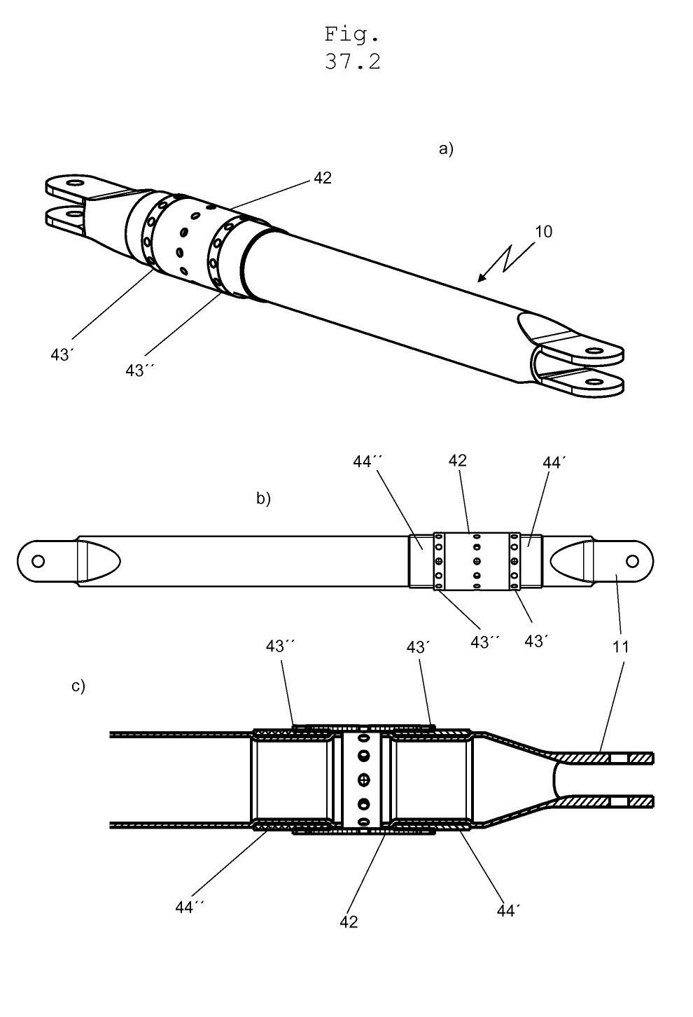

FIG. 36 section of a strut continuously adjustable in length with attached turnbuckle
a) with simple brackets at the bolt ends,
b) with bracket and fork bracket at the bolt ends;

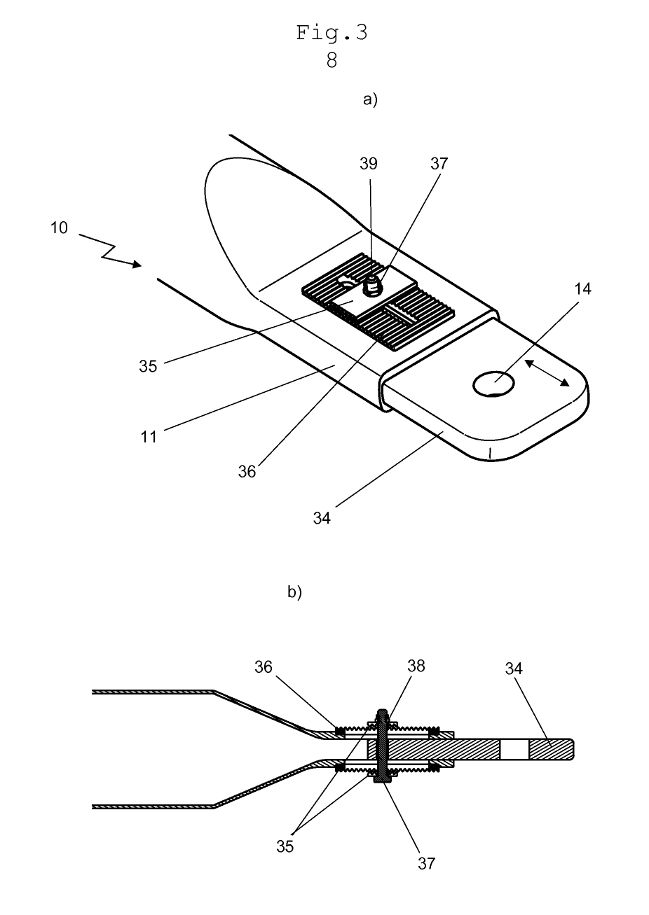

FIG. 37.1 a strut continuously adjustable in length with inner threads running in opposite direction (turnbuckle principle),
a) in perspective representation,
b) in top view,
c) in sectional view;

FIG. 37.2 a strut continuously adjustable in length with outer threads running in opposite direction (turnbuckle principle),
a) in perspective representation,
b) in top view,
c) in sectional view;

FIG. 38 a strut stepwise adjustable in length with tooth plate adjustment
a) in perspective representation,
b) in sectional view;

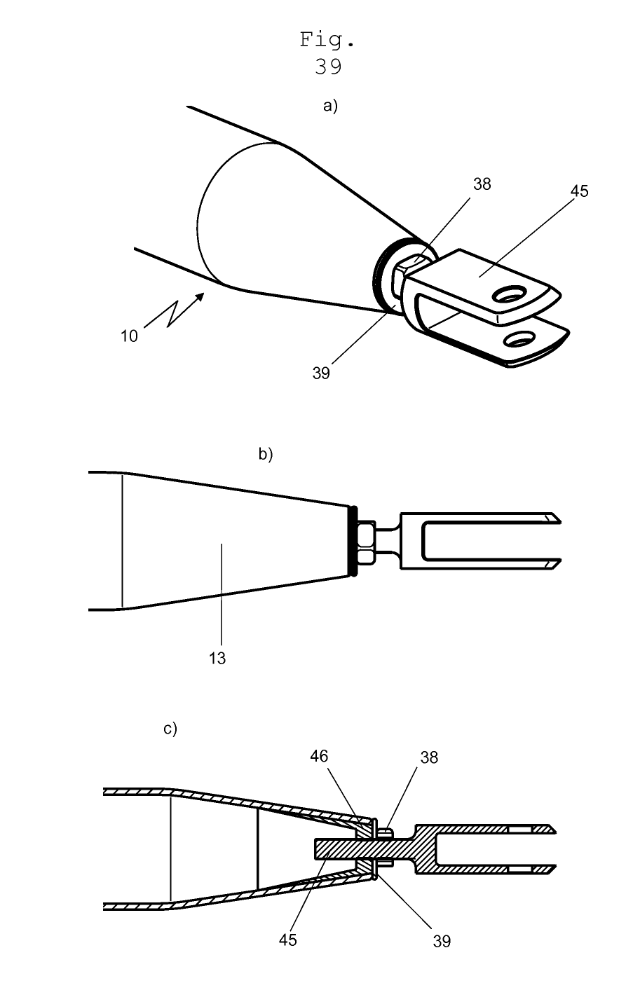

FIG. 39 a strut tapering into a cone on one end, stepwise adjustable in length with threaded connection,
a) in perspective representation,
b) in side view,
c) in sectional view;

FIG. 40 a strut stepwise adjustable in length with increased thickness on one end,
a) in perspective representation,
b) in top view,
c) in sectional view;

FIG. 41 a seat beam blank, for example for an aircraft seat;

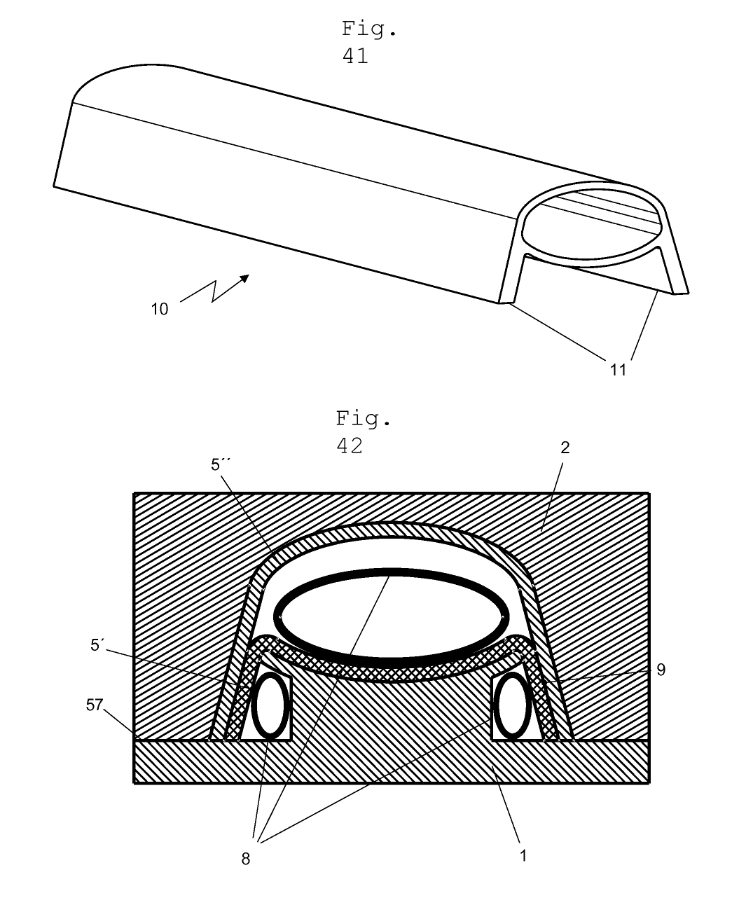

FIG. 42 a seat beam blank inside a hollow mould in cross-sectional view;

FIG. 43 a seat beam with integrated strengthening rib;

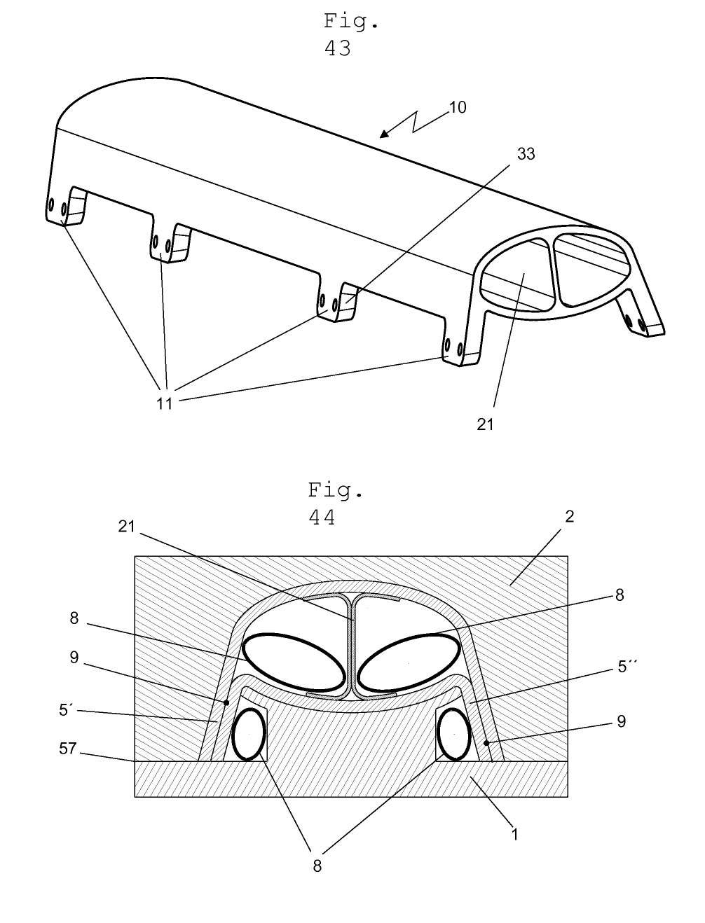

FIG. 44 a seat beam with integrated strengthening rib inside a hollow mould in cross-sectional view;

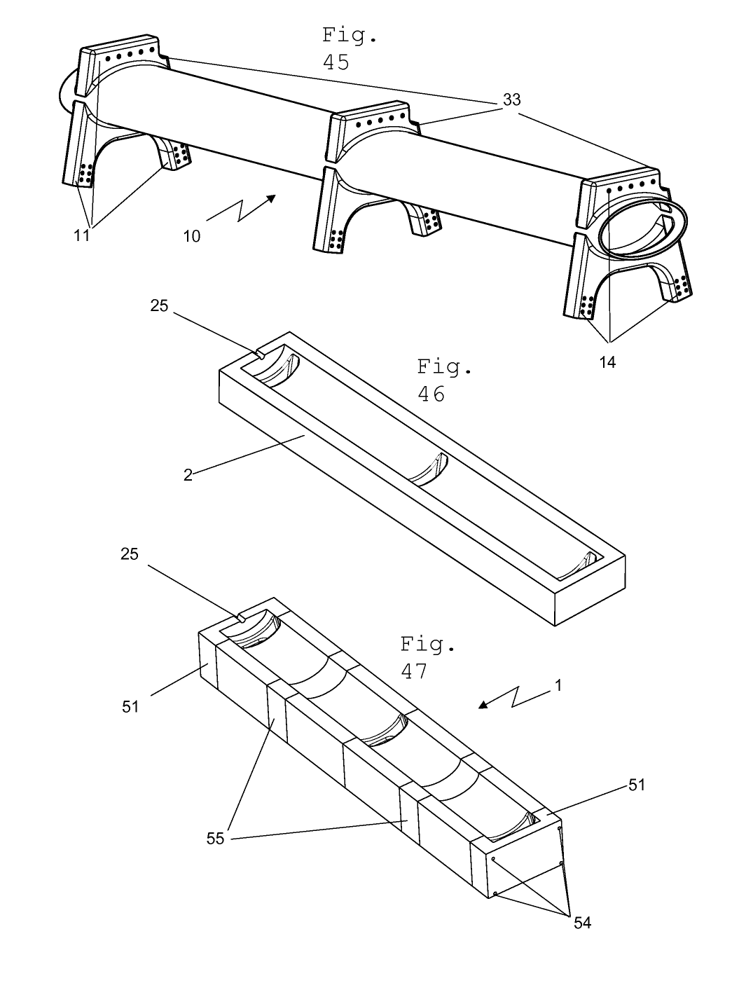

FIG. 45 a seat beam with integrated connections for structural components;

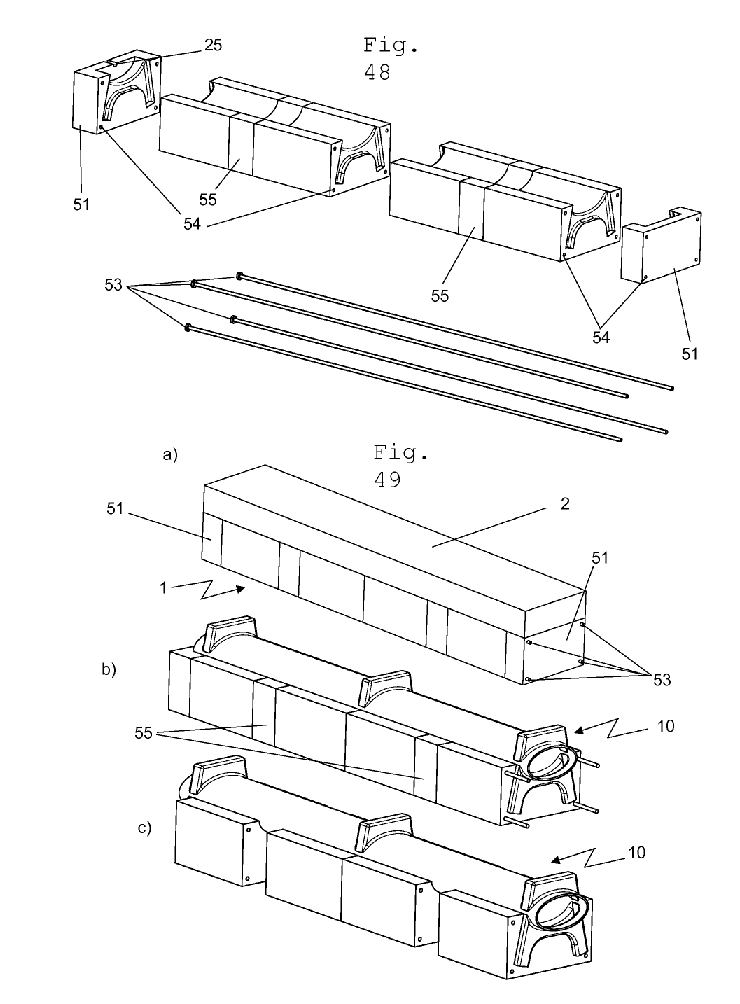

FIGS. 46 and 47 the top and bottom mould halves for the seat beam as in FIG. 45;

FIG. 48 a sectioning of the mould half as in FIG. 47;

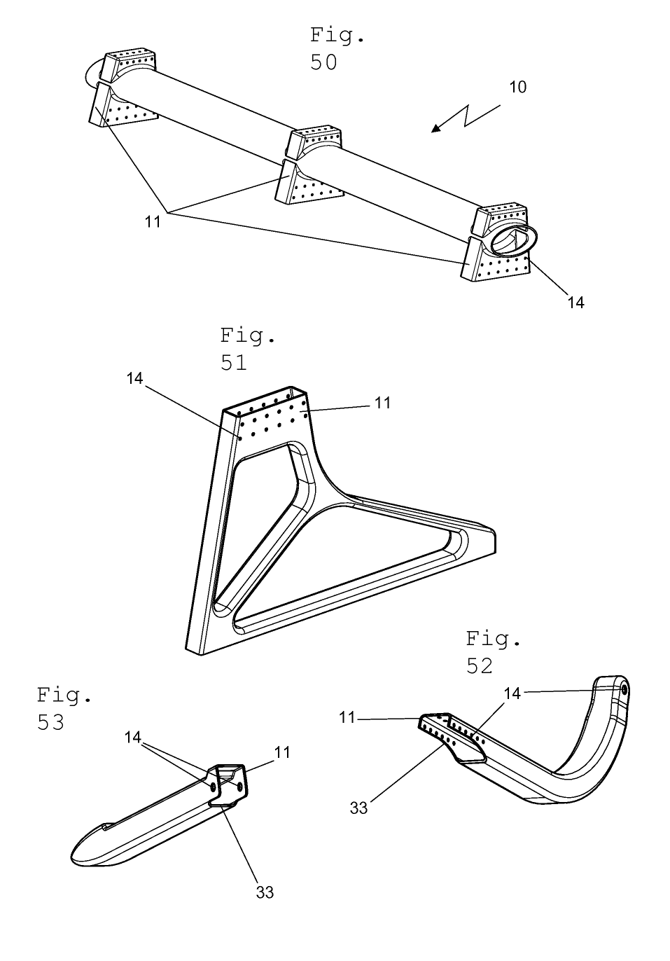

FIG. 49 a description in pictures for removing the seat beam as in FIG. 45 from the hollow mould after curing;

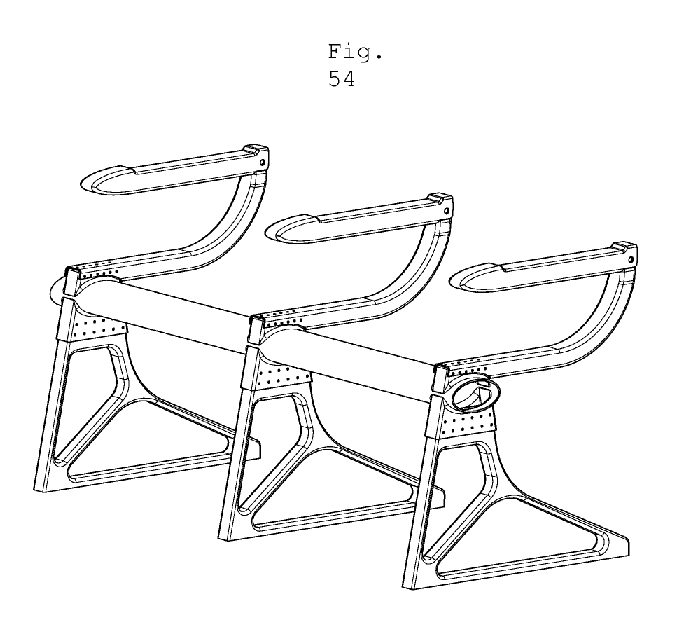

FIG. 50 another embodiment of the seat beam similar to FIG. 45;

FIG. 51 a seat base structure produced in accordance with the invention;

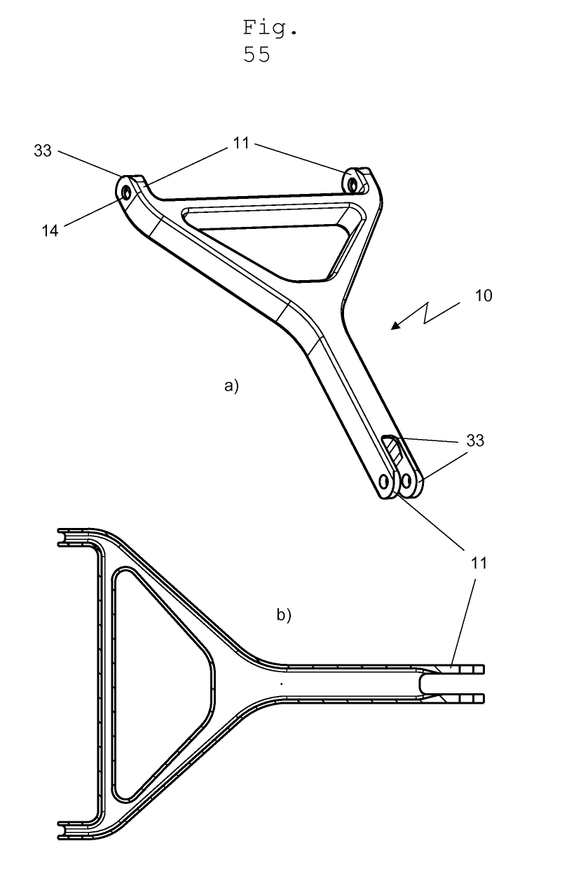

FIG. 52 a structure for connecting an arm rest as in FIG. 53 produced in accordance with the invention;

FIG. 53 an arm rest structure produced in accordance with the invention;

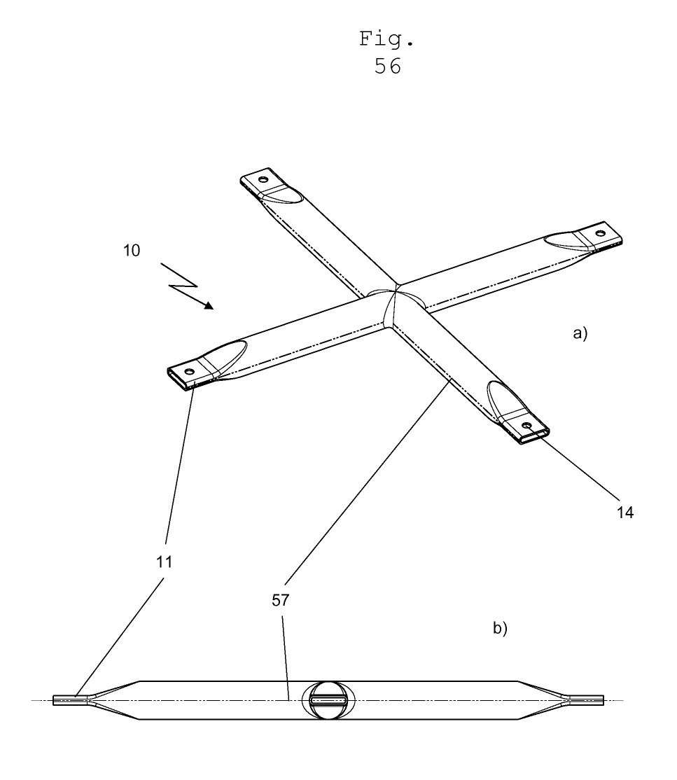

FIG. 54 assembly of the structures as in FIGS. 50 to 53;

FIG. 55 a fork strut produced in accordance with the invention, for example for the nose landing gear of an aircraft;

FIG. 56 struts crossed in the centre at right angles with brackets
a) in perspective view, and
b) in side view;

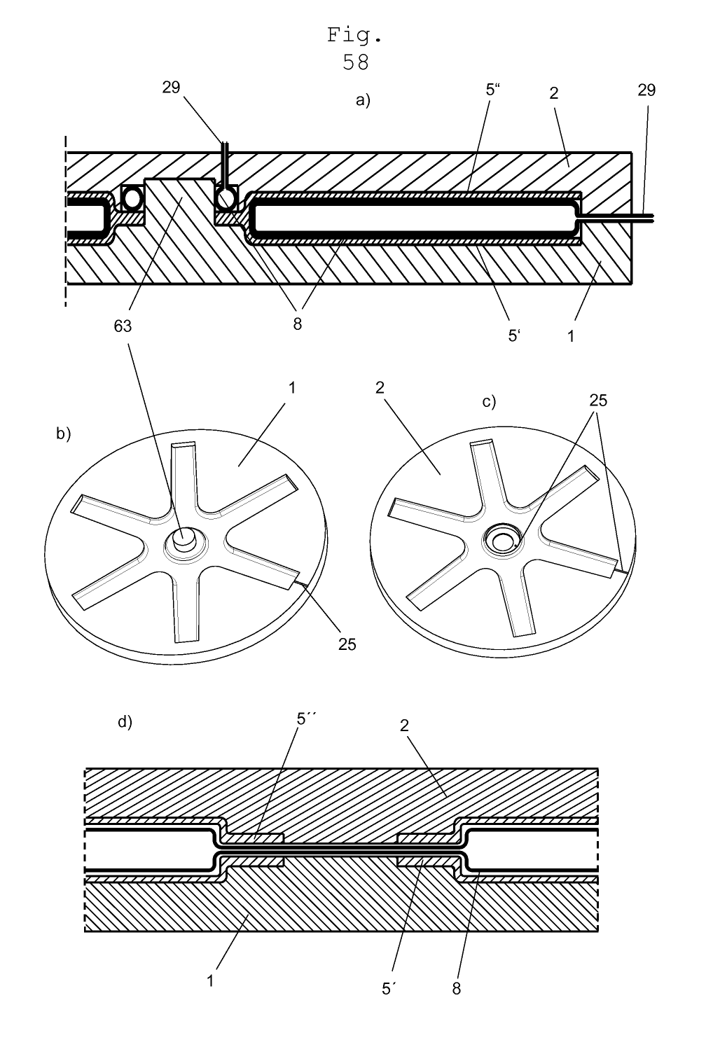

FIG. 57 a star-shaped hollow body with centrally incorporated flange
a) in perspective representation,
b) in front view,
c) in side view;

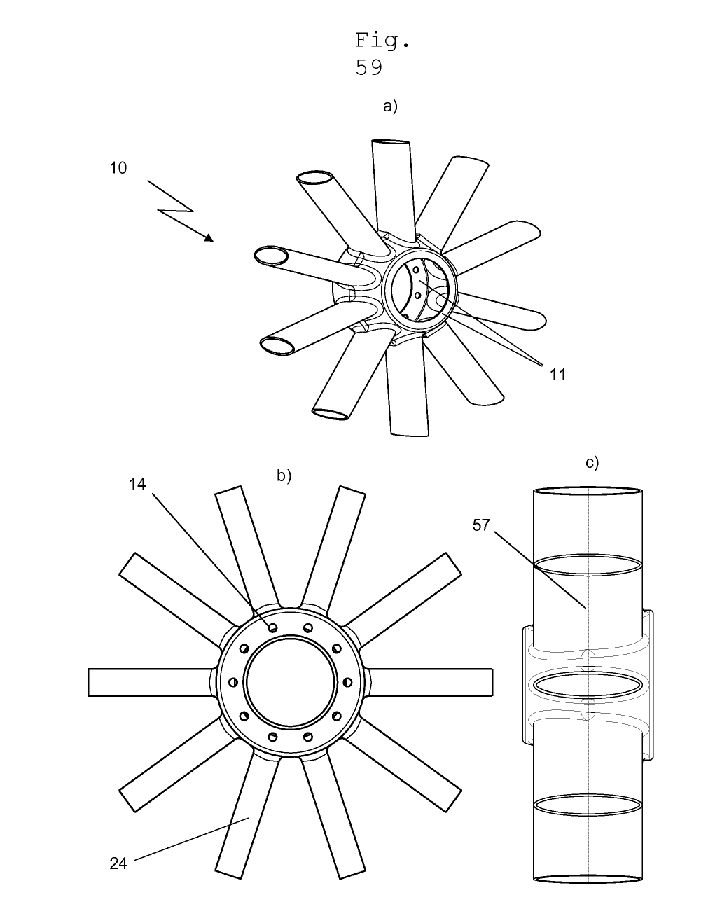

FIG. 58 hollow mould variations for star-shaped hollow bodies as in FIG. 57, where
a) to c) show a first variation using two balloons, and
d) shows a second variation using one balloon;

FIG. 59 a star-shaped hollow body with integrally incorporated hub
a) in perspective representation,
b) in front view,
c) in side view;

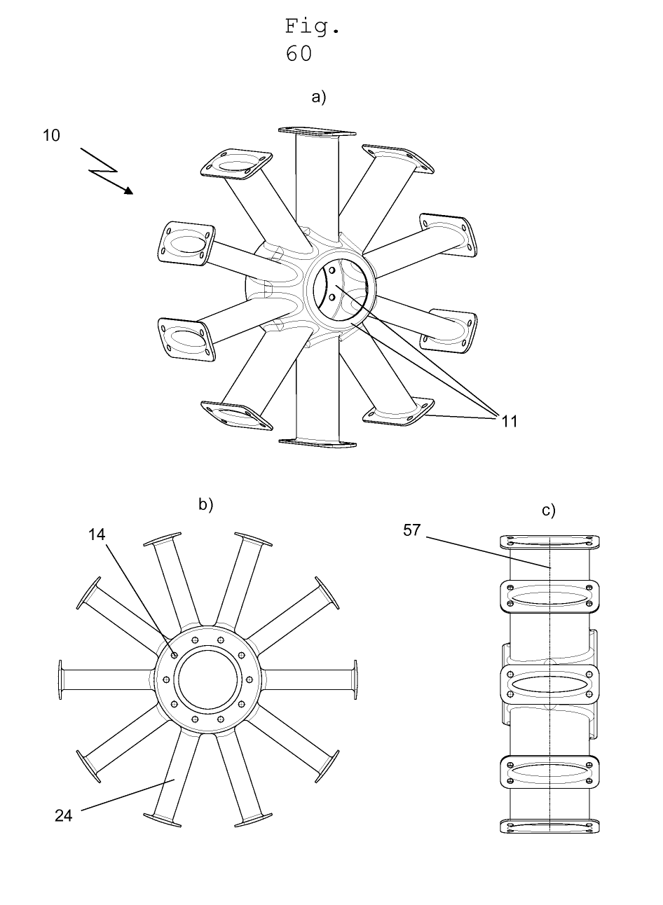

FIG. 60 a star-shaped hollow body with incorporated hub and integrated end flanges
a) in perspective representation,
b) in top view,
c) in side view;

FIG. 61 a wheel rim with integrally incorporated hollow spokes
a) in perspective representation,
b) in side view,
c) in sectional view;

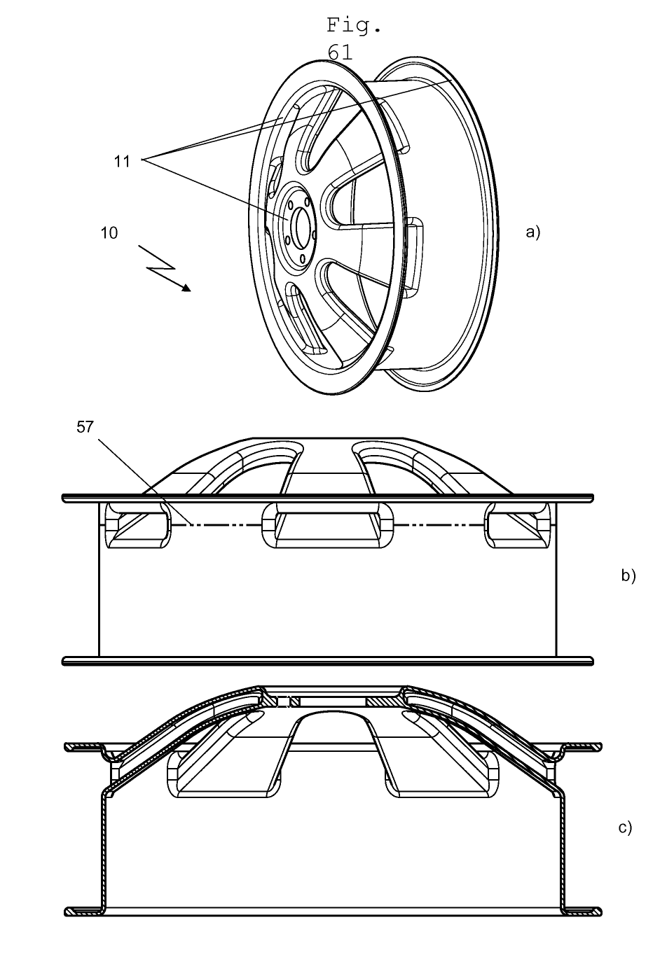

FIG. 62 assembly of the mould for the wheel rim as in FIG. 61;

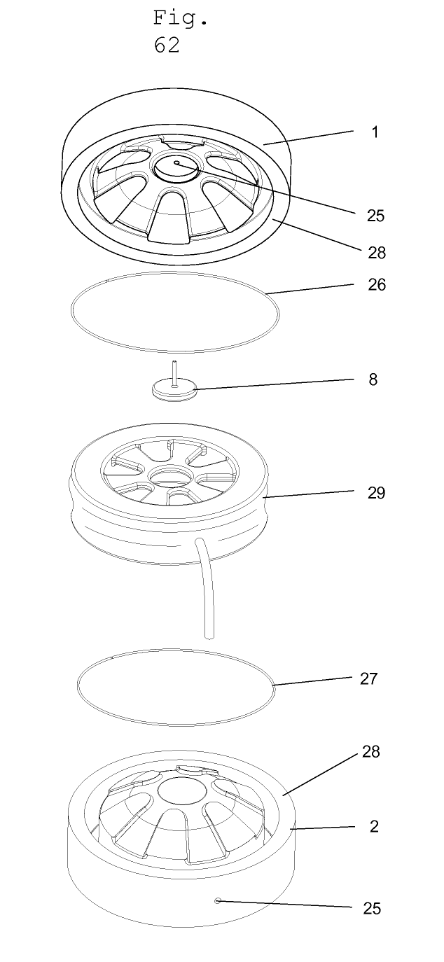

FIG. 63 the assembled mould for the wheel rim as in FIG. 61 in sectional view including mould balloons;

FIG. 64 a rectangular control flap open at one side
a) in perspective view, and
b) in side view;

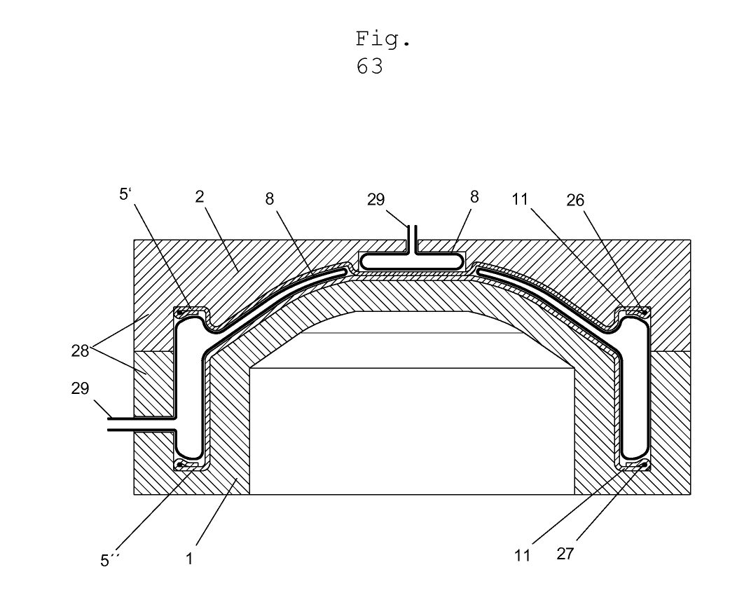

FIG. 65 illustration of the production process in principle shown in a cross-sectional representation of the control flap as in FIG. 64;

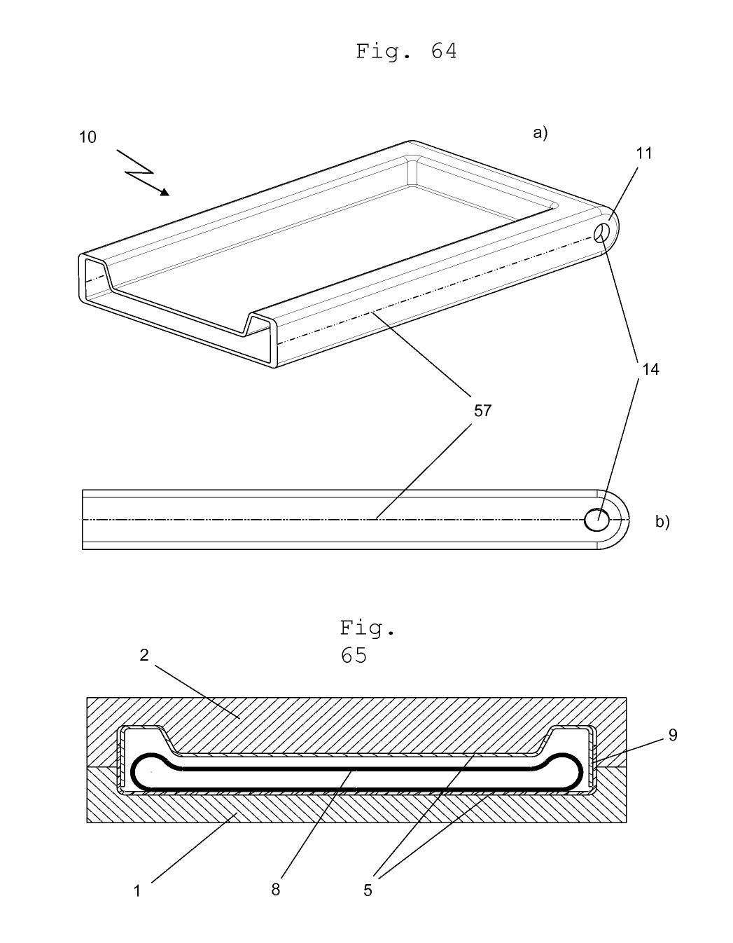

FIG. 66 a rectangular control flap open at one side similar as in FIG. 64, but with inner rib
a) in perspective view, and
b) in side view;

FIG. 67 a rectangular control flap open at one side similar as in FIG. 66, but with strengthening crease
a) in perspective view, and
b) in side view;

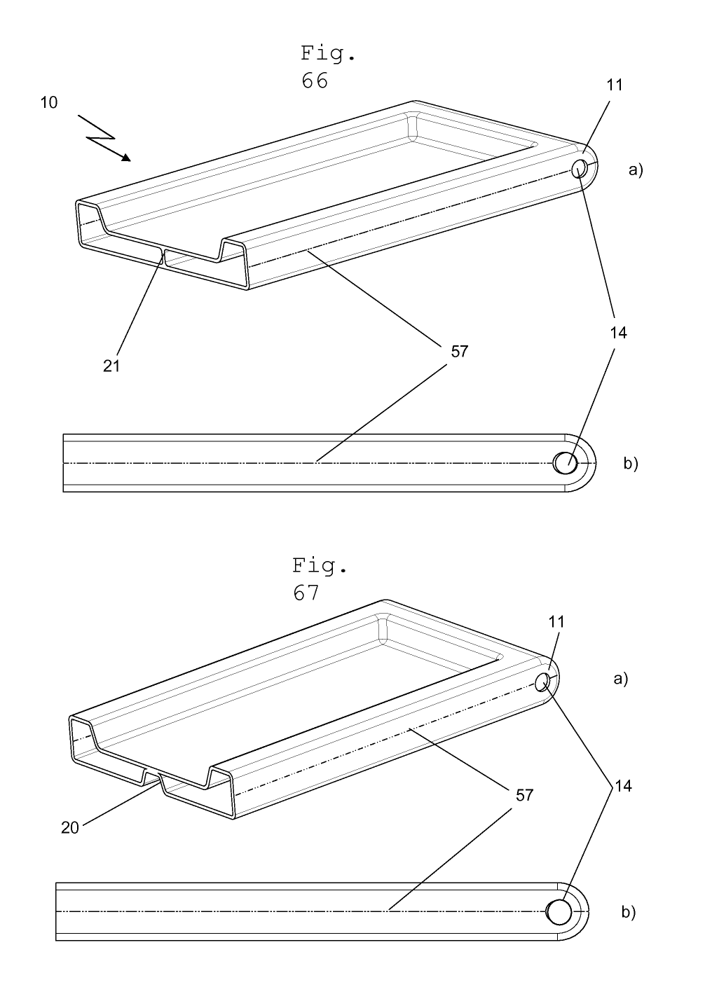

FIGS. 68 to 70 control flaps for aircraft and re-entry vehicles for space flight made of composite fibre ceramics;

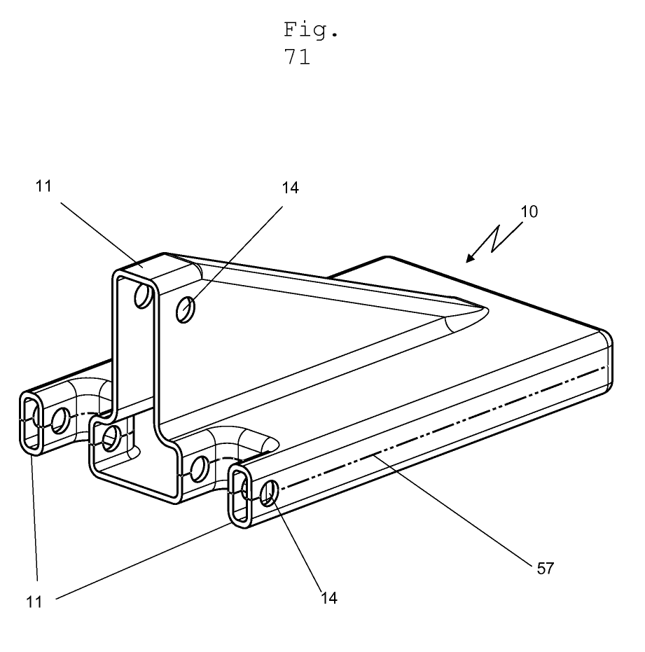

FIG. 71 another embodiment of a control flap;

FIG. 72 other embodiments of control flaps for aircraft and re-entry vehicles
a) with horizontal partition plane,
b) with vertical partition plane;

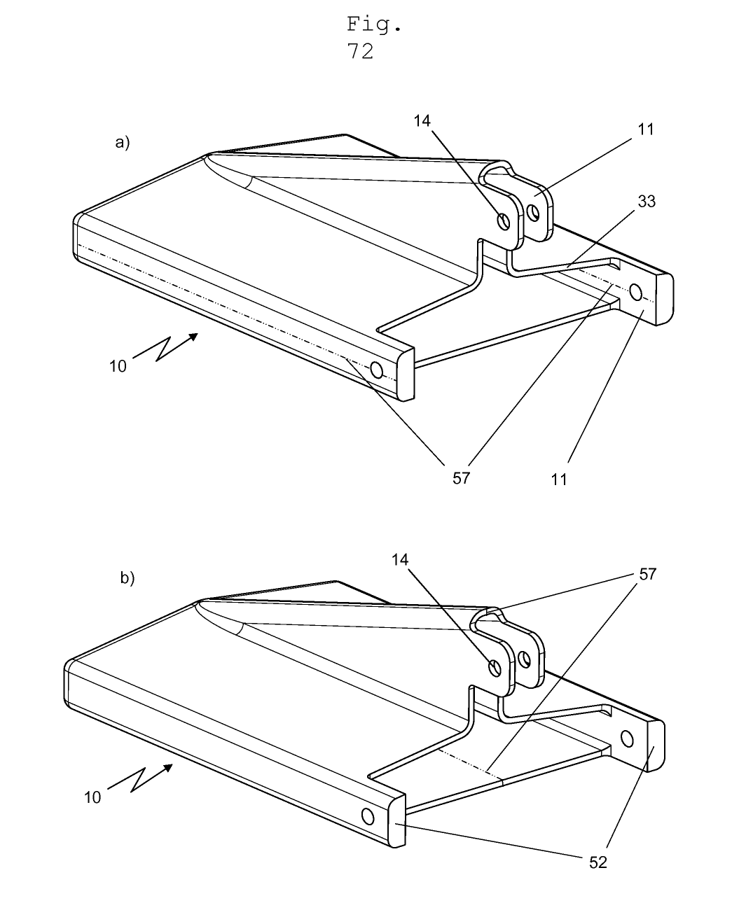

FIGS. 73 to 75 mechanisms for actuating control flaps;

FIG. 76 a blade with integrally incorporated flange, for example for wind turbines,
a) in perspective representation,
b) in side view;

FIG. 77 a hollow body shaped as a brake disc;

FIG. 78 illustration showing the production process of a brake disc as in FIG. 77 produced in accordance with the invention;

FIG. 79 hollow body shaped as the air intake front lip of a turbine engine, for example of gas turbines of aircraft,
a) isometric front view,
b) isometric rear view, and
c) sectional view;

FIG. 80 the bottom mould half for the air intake front lip as in FIG. 79
a) isometric,
b) in sectional view;

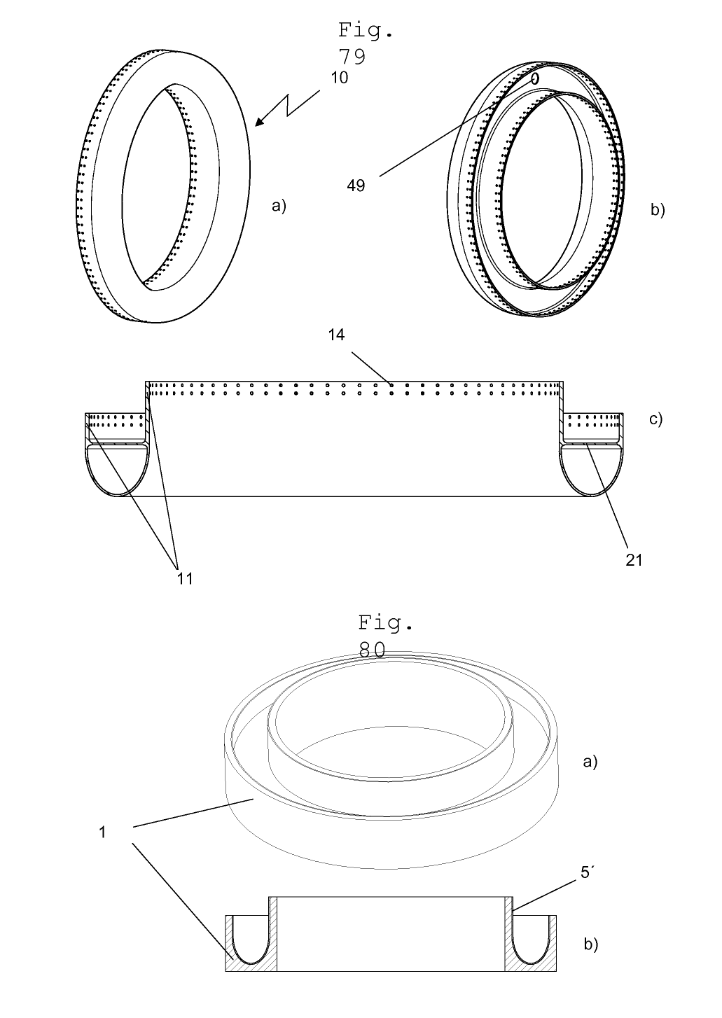

FIG. 81 the top mould half for producing the air intake front lip as in FIG. 79 with placed laminate layers;

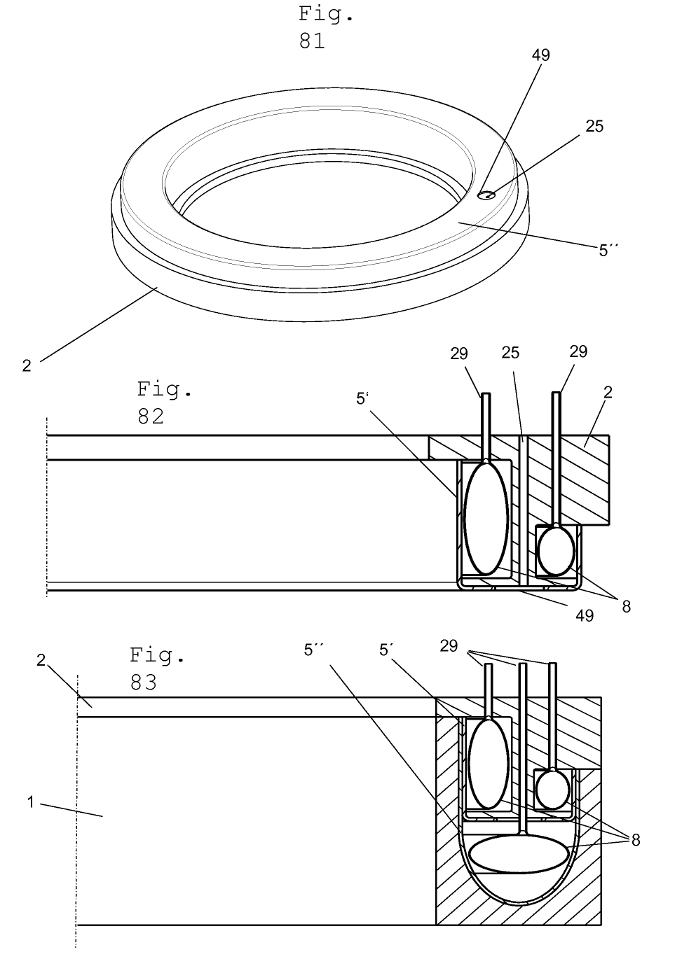

FIG. 82 structure of the top mould half as in FIG. 81 in sectional view including laminate layers and balloons;

FIG. 83 the assembled mould halves from FIGS. 80 and 81 in sectional view;

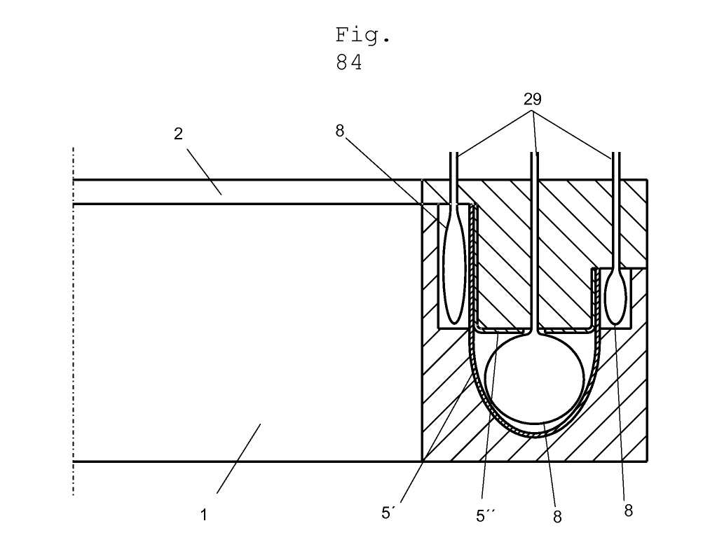

FIG. 84 another mould structure for producing an air intake front lip as in FIG. 79;

FIG. 85 a fuselage segment of an aircraft produced in accordance with the invention with integrally incorporated stringers and ribs prior to mechanical processing;

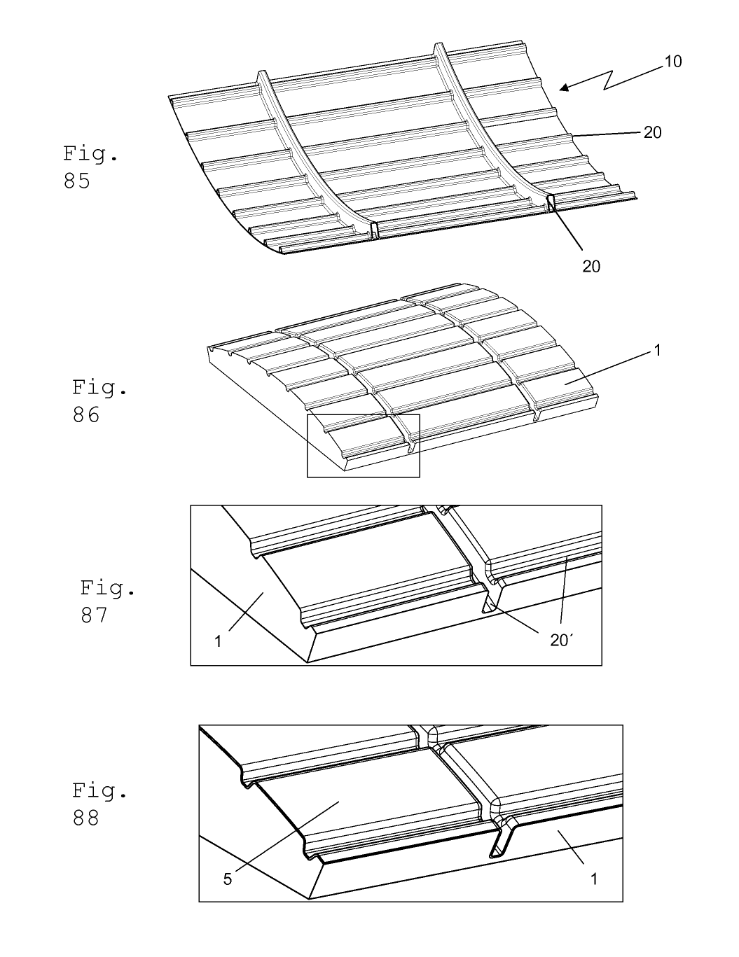

FIG. 86 the bottom mould half of the fuselage segment as in FIG. 85;

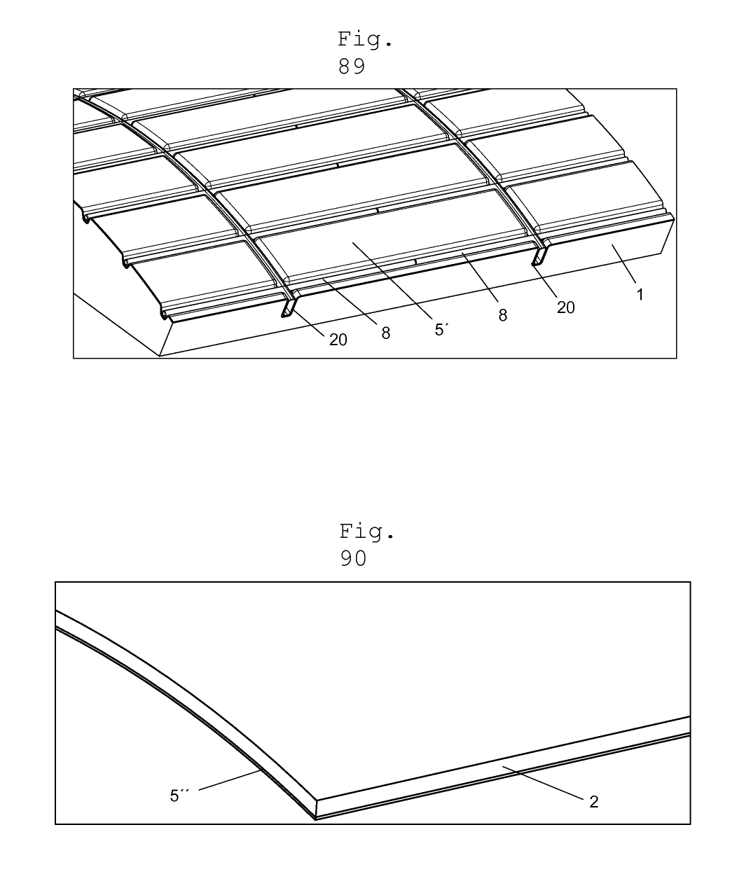

FIG. 87 an enlarged detailed view from FIG. 86;

FIG. 88 a bottom mould half laminated with semifinished fibre products for producing a fuselage segment as in FIG. 85;

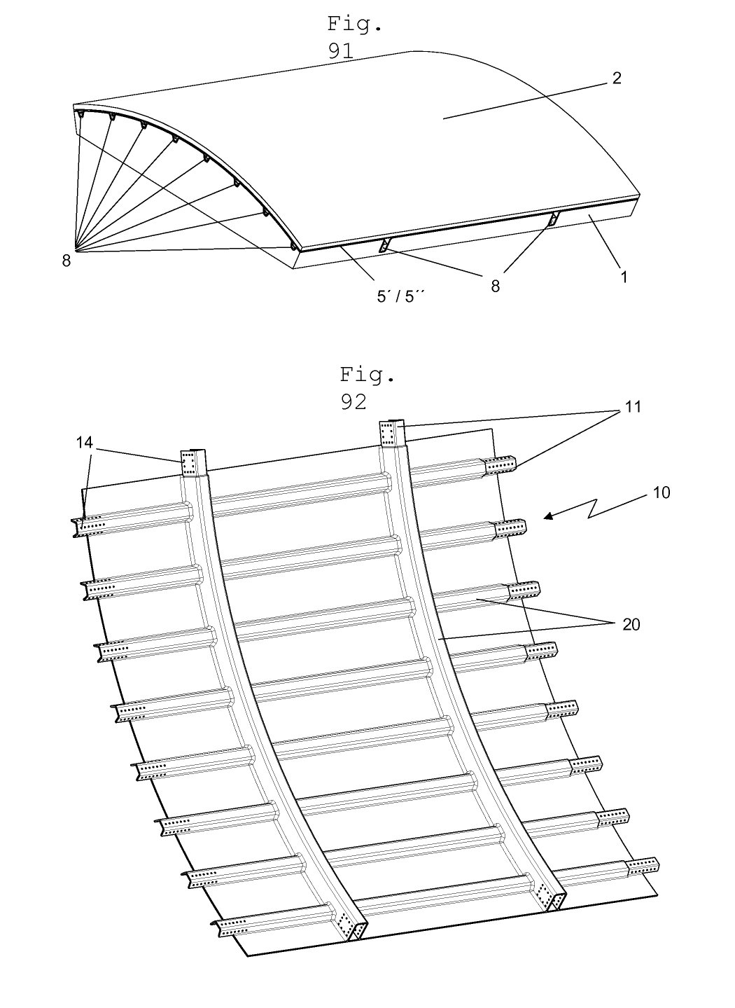

FIG. 89 the bottom mould half as in FIG. 88 with inserted mould hoses similar to those in FIG. 32 d);

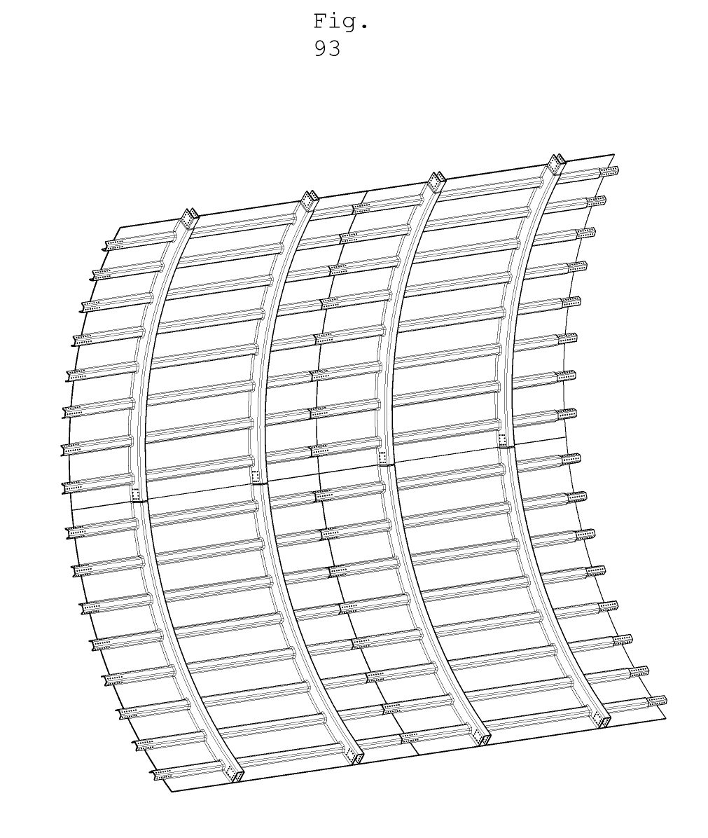

FIG. 90 the top mould half laminated with fibre material for producing the fuselage segment as in FIG. 85;

FIG. 91 the entire mould structure for producing the fuselage segment as in FIG. 85;

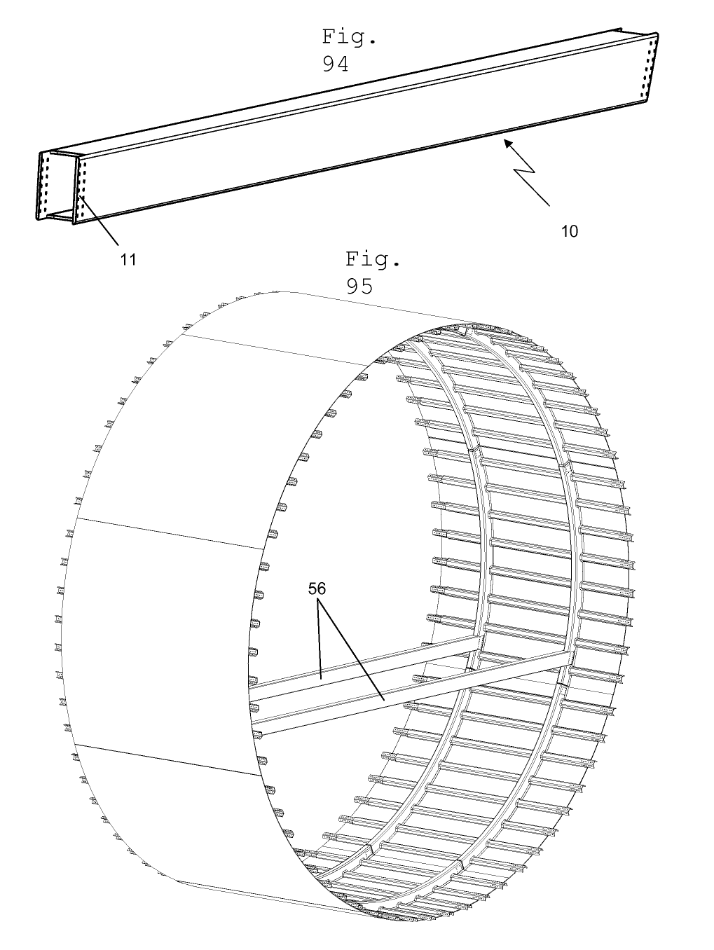

FIG. 92 a fuselage segment produced in accordance with the invention as in FIG. 85 with integrally incorporated connection brackets after drilling and contour machining;

FIG. 93 four outer shell panels combined to each other in order to form a sub-segment of an aircraft fuselage;

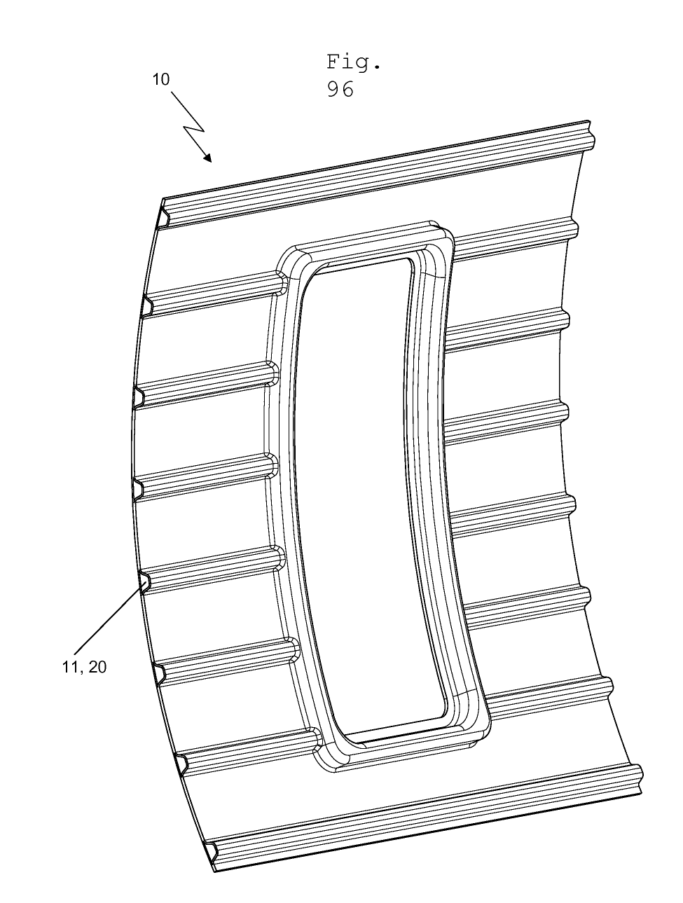

FIG. 94 a hollow body shaped as a floor crossbeam produced in accordance with the invention;

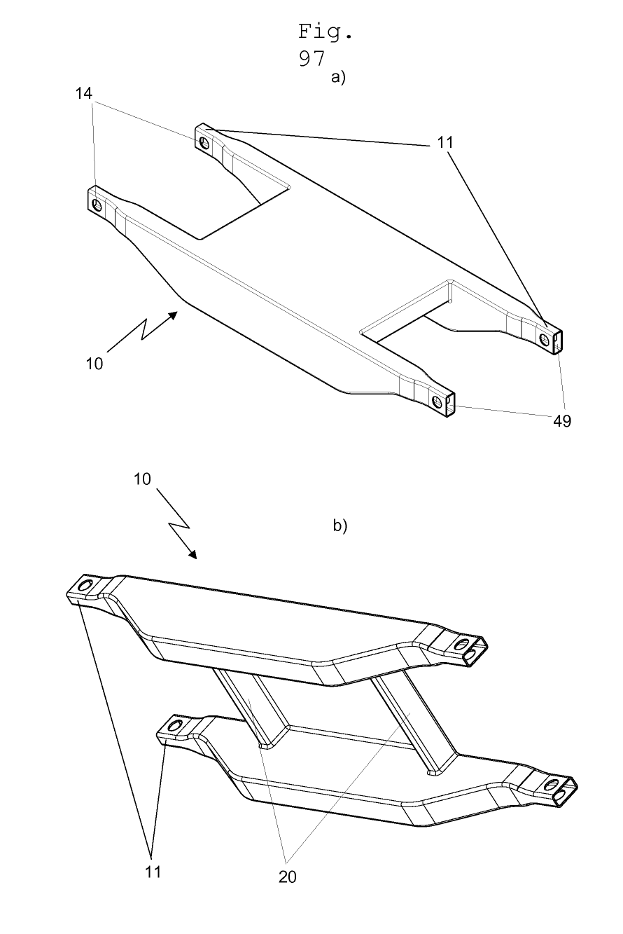

FIG. 95 a sub-segment of an aircraft fuselage with fuselage segments and floor crossbeams produced in accordance with the invention;

FIG. 96 a hollow body shaped as an outer shell panel with integrated stringers and integrated frame for a passenger door;

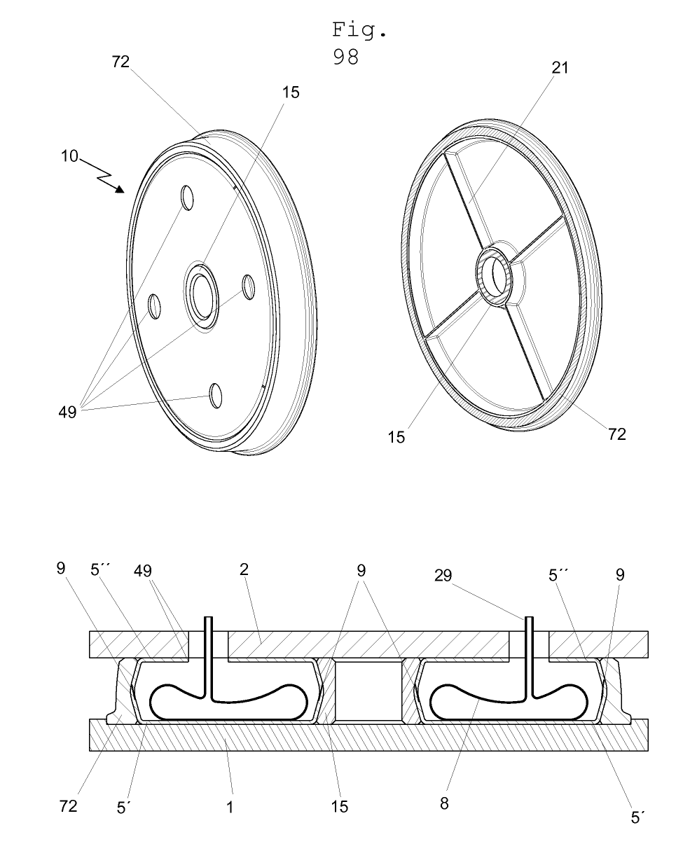

FIG. 97 a bogie for railway or cableway carriages
a) isometric from above, and
b) isometric from below;

FIG. 98 a wheel for a high-speed railway vehicle
a) isometric,
b) isometric in sectional representation, and
c) the mould structure in sectional representation.

FIG. 1 shows, as a possible embodiment of a fibre-reinforced hollow body 10 produced in accordance with the invention, a strut with fork or slot-shaped connection brackets 11, both in side view (a) and front view (b) as well as in perspective representation (c). It features a tubular/cylindrical centre part 12 from which wedge or ramp-shaped sections 13 taper into integrally incorporated brackets 11. The brackets 11 feature approximately centred bores 14 fitted with bushings 15 that are each equipped with a collar 15. The collar prevents any possible abrasion by a load-inducing pin (not shown) when transmitting bending or torsion forces.

FIG. 2 also shows a strut with fork or slot-shaped brackets 11. The hollow centre part 12, however, is oval in cross-section, as can be seen in the side view (b). All other characteristics are identical with the strut as in FIG. 1 and feature the same reference numbers.

The struts (fibre-reinforced hollow bodies 10) in FIGS. 3 and 4 have the same essential characteristics as those in FIGS. 1 and 2 and therefore again feature identical reference numbers. In addition, within their cylindrical or oval centre part 12 they feature recessed 16 or protruding 17 flat-shaped surfaces where transversal forces can be induced. The brackets 11 in FIG. 3 are designed to be inserted into fork brackets and are as such tongue-shaped.

FIG. 5 shows the cross-section of the centre part 12 with a protruding surface 17 as in FIG. 4 at a place where transversal forces can be induced by means of, for example, a pin (not shown).

FIG. 6a then shows a hollow mould half (1, 2) designed in accordance with the invention in perspective representation, and FIG. 6b shows a longitudinal section through the same hollow mould half. FIGS. 6a and 6b clearly illustrate a half negative mould of a strut in terms of the above embodiments, in particular the changing cross-section dimensions from the centre part 12′ to the end areas (brackets) 11′ via the ramp-shaped sections 13′. This trough-shaped negative mould is laminated with impregnated semifinished fibre product 5 (FIG. 7 and the following), and those again are covered, if required, with a venting fabric 7, onto which (once the hollow mould halves 1, 2 are locked) pressure is exerted before and during curing in such a way that the fibre placements are pressed against the inner wall of the hollow body mould. In FIG. 6c both laminated hollow moulds 1, 2 are shown shortly before being joined. At this process stage, the hose 8 pressing the laminates against the inner walls of the hollow moulds has already been placed into the bottom hollow mould.

FIGS. 7 to 9 illustrate a production process for the present invention. It especially applies for all cross-section designs of the struts shown above, regardless whether they should have a circular or rectangular outer shape, for example.

FIG. 7 shows this production process for a bottom 1 and FIG. 8 for a top 2 hollow mould half, also referred to as bottom/top mould. Onto both mould halves 1 and 2 open towards the top, preferably one shoulder 3, 4 each is placed and impregnated semifinished fibre product 5 is laminated into the mould all the way up to the stop surfaces 18 of the shoulders 3, 4. Subsequently, if required, a venting fabric 7 is placed onto the semifinished fibre product 5. For the embodiment shown here, a hose 8 is inserted into the bottom mould half 1. Once the shoulders 3, 4 are removed, the top mould half 2 can be placed onto the bottom mould half 1 and both can be firmly locked. The protruding edge strips 6 are intended as overlap 9 in the seam area of the hollow body 10 so that the halves will be joined (bonded) easily as soon as the hose 8 is pressurised. This applies even more if heat is induced additionally.

This results in the following process steps for producing a hollow body in accordance with the invention:
1.1 Fasten shoulders 3 and 4 onto the relevant faces of the open hollow mould halves 1 and 2.
1.2 Drape the concave hollow mould halves 1 and 2 with semifinished fibre product and/or laminate 5 so that protruding strips 6 are formed at the shoulders 3, 4.
1.3 If required, place venting fabric 7 onto the semifinished fibre product 5, including or excluding the protruding strips 6.
1.4 Insert hose (balloon) 8 made of an isotropic elastic material into the bottom mould half 1.
1.5 Remove shoulders 3, 4 from the hollow mould halves 1 and 2.
1.6 Place the hollow mould halves 1 and 2 fitted with laminate onto each other and lock them firmly, for example, with bolts/screws.
1.7 Seal one hose end, unless a balloon is used, suck off and/or displace any air contained within the hollow mould, inflate the hose with pressurised gas.
1.8 Cure under controlled gas pressure and temperature conditions in the oven or autoclave.
1.9 Open hollow mould, remove hose/balloon, extract the fibre-reinforced plastic hollow body, contour-machine the brackets, drill holes, insert cover discs and/or bore bushings.

In particular in FIG. 10 it can be seen that the placement of the semifinished fibre products 5 is done generally not evenly but rather according to an expected load profile, i.e. according to an expected stress of the fibre-reinforced hollow body 10 along its individual sections 11, 12, 13. For example, in the centre part 12″ unidirectional fibres are placed in longitudinal direction and at ±45° to the longitudinal axis. In the end area (brackets or other connection elements) 11′ the placement is done isotropically, that means along, across the longitudinal axis and at less than ±45° to it. In between the centre part 12 and the end area of the brackets 11 or similar incorporated elements, i.e., in the wedge or ramp-shaped section 13, placement is done in gradually staged fashion. In FIG. 10 the corresponding sections are marked 11″, 12″, and 13″, which correspond to the hollow mould areas 11′, 12′, and 13′ as in FIG. 6.

The semifinished fibre products 5 can be laminated in various ways in layers into the mould cups 1 and 2 and against the stop surfaces 18 of the shoulders 3 or 4, respectively.

FIG. 11 shows a placement with very high protrusions 6 above the edge. The protruding edge strips 6 are rested against the shoulders 3, 4 and a rail 19 with L-profile. Rail 19 allows to join the edge strips 6 free of creases. This can be done with and without overlap of the edge strips 6.

In FIG. 12 the edge strips 6 are prepared for a placement intended for maximum a butt joint, and in FIG. 13 for a placement with overlap. Once the mould halves 1 and 2 are closed and the hose 8 is inflated, the edge strips 6 join in the desired way with the semifinished fibre product 5 placed into the top hollow mould half 2.

FIG. 14 shows how a fibre-reinforced hollow body 10 can be produced featuring only one overlap. For this purpose, the edge strips 6 are overlapped, as shown in FIGS. 11 and 13, and pressed into the unlaminated top mould half 2 by means of the hose 8. For hollow bodies with, for example, suspension brackets or fins, it is useful to position the overlap along the separation line of the mould halves 1, 2, as shown in FIG. 15. Further details in this regard will be discussed further on.

As in FIG. 16, the layers of the semifinished fibre product 5 are fanned out along the later seam lines so that, when the mould halves 1, 2 are placed on top of each other, the fanned out layers will fit into each other in alternating fashion. For this purpose, the mould halves 1, 2 are again provided with shoulders 3 and L-rails 19 and 19′. While the bottom mould half features a shoulder 3 in collaboration with a rail 19 in order to split the fibre placement by a specific level, the other shoulder 19′ at the top mould half is intended to keep the laminate slightly away from the mould wall. In this way, an interlocking bond is achieved. This “interlock” seen in FIG. 17 increases the quality of the joint.

FIGS. 18 to 22 show resulting cross-sections, here cylindrical centre parts 12 with various overlap designs. These are the result of differences in connection with the positioning of the protruding edge strips 6 prior to joining the mould halves 1, 2. As can easily been seen, the positioning of the edge strips 6 as in FIG. 9 corresponds with the result in FIG. 18; equally the positioning in FIGS. 12, 13, 14, 15 and 17 corresponds with the results in FIGS. 19, 20, 21 and 22 in this sequence and matching.

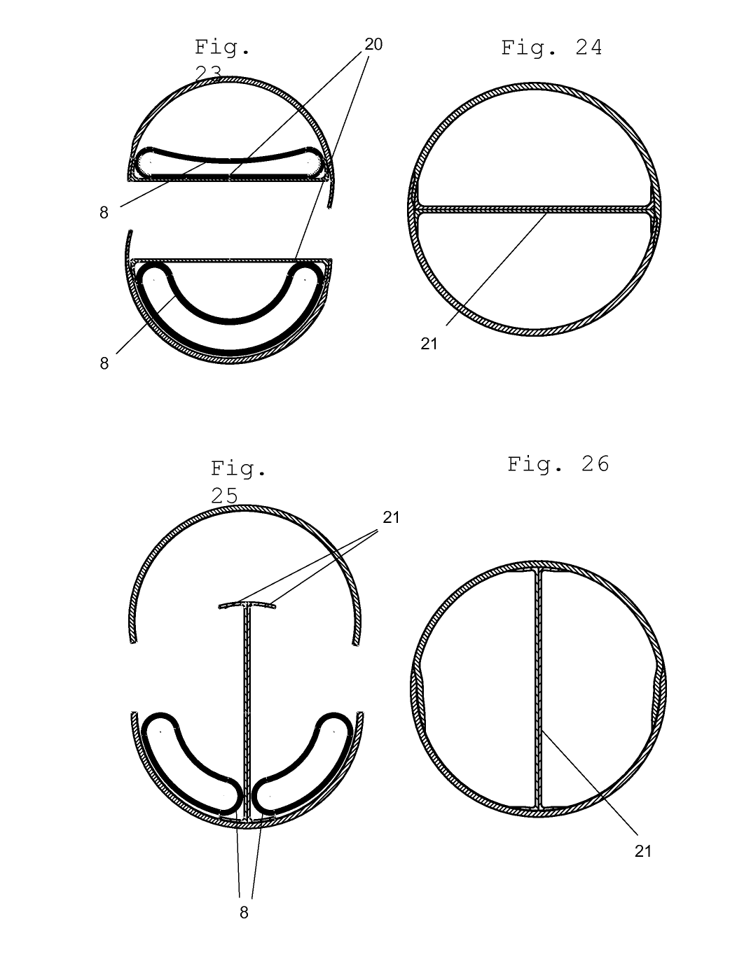

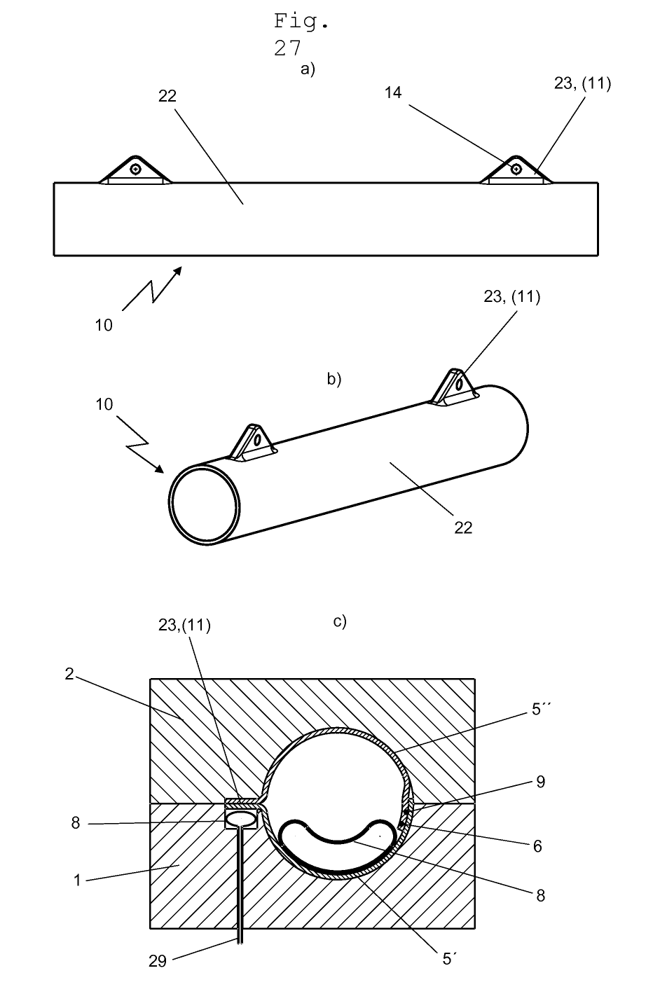

With only minor changes, a fibre-reinforced hollow body 10 with fibre-reinforced inner rib 21 can be produced by using two U-shaped rib bridges 20, for example made of prepregs, and two hoses connected in a communicating manner. This is shown in the diagrams of FIGS. 23 and 25. The U-shaped rib bridges 20 are each joined in the bottom 1 and top 2 mould half to the previously placed fibre mat 5. FIGS. 24 and 26 each show a section through the finished product.

FIG. 27 shows a fibre-reinforced tube 22 with suspension brackets 23 integrated into the tube mantle. The tube 22 and the suspension brackets 23 are produced integrally in one part in terms of the method according to the invention.

FIGS. 28 and 29 each show fibre-reinforced tubes 24 with one, respectively two integrally incorporated flanges 11 that are produced in terms of the method according to the invention. For joining the individual tubes 24 or tube components with each other, as, for example, pipe bends as in FIG. 30, the flanges 11 may be provided again with bores. Besides, in principal pipe bends can be produced in the same way as the straight tubes in FIGS. 28 and 29.

FIG. 31 shows in perspective a fibre-reinforced finned tube (a), a finned tube wall (b) consisting of the same material, and two hollow mould variations (c) and (d) used to produce such components manufactured in terms of the method according to the invention. They may consist of plastic or ceramic (CMC), for example. The integrally incorporated fins/bridges can be shorter than the tube(s) (not shown). Such finned tubes or tube walls can be applied in heat and refrigeration engineering, for example as refrigeration pipes, for building heat shields, heat exchangers, etc.

The manufacturing of a panel segment made of fibre-reinforced plastic to be fitted with integrally incorporated struts with sliding/connection brackets is illustrated, in principle, in FIGS. 32 and 33. In deviation from the shown illustration, the panel segments may also be curved. The sliding/connection brackets can be clearly seen in FIGS. 92, 93, and 95. Within mould half 1, grooves 20′ run parallel to each other, here in equal distances, in order to form longitudinal and transversal reinforcements 20. Once the fibre mats are placed, i.e., form half 1 is laminated, mould hoses/mould balloons 8 (here four) are fitted into the grooves 20′ prepared for this purpose and mould 2 equally laminated with fibre mats (prepregs) 5″ is lowered onto mould 1. Using exterior pressure forces that press the mould halves 1 and 2 together and counter the pressure of the mould hoses 8, the laminate contact surfaces/overlaps 9′ and 9″ will bond so that under heat the semifinished fibre compound product will cure to exact dimension inside the oven or autoclave. As shown in FIG. 33, the exterior forces, taking advantage of the exterior pressure, can be generated by means of a vacuum jacket 59, also known as vacuum bag, enclosing mould halves 1 and 2, when connecting them to a vacuum pump (not shown here). Additionally or independent from this, controllable pneumatic or hydraulic forces (power devices, pressure sleeves, etc.) 62 can be useful. Ventilation fabric 7 (=venting fabric) can be placed between the vacuum jacket 59 and the mould halves 1 and 2 in order to enhance the effective vacuum and thus venting via the vacuum connection.

Instead of prepregs, fibre-reinforced components, such as, for example, the panel segment in FIG. 32 a), may also be produced with dry textile fibre tissues (semifinished fibre products). In order to prevent the individual fibre layers from sliding out of alignment after they have been placed into the mould half, so-called preforming is applied. With this method, a thermoplastic or duroplastic binding agent is added to the individual fibre layers, which are then placed onto a positive or negative mould. In order to fix the layers into place they are covered with a sheet and with a sealant their edge is sealed all around on the positive/negative mould. When the air underneath the sheet is evacuated, the outer air pressure comes into effect and presses the individual fibre layers firmly onto or into the positive/negative mould. By inducing heat, the binding agent is then activated, penetrates the dry fibre ply and subsequently cures. The fibre composite generated in this way will be treated as dry semifinished fibre product during further processing.

Once inserted into the mould half 1, the preformed semifinished fibre product 5′ is infiltrated with resin. FIG. 33 e) shows the mould structure in principle. Inside the mould half 1 are grooves for integrally incorporating the longitudinal and transversal reinforcements 20 of the panel segment (FIG. 32 a)) using the one shot curing method. Underneath the fibre tissue 5′ venting fabric 7 can be placed, if required. Inside the grooves 20′ lined with fibre material 5′ mould hoses 8 are fitted under which, if required, U-shaped venting fabric 7 can also be placed. The fibre tissue 5′ and the mould hoses 8 are covered by preformed fibre tissue 5″, on top of which usually there is the tear-off foil 66, the distributor fabric 67 and a semi-permeable foil 65. The latter is permeable for gas and impermeable for resin.

On top of the semipermeable foil 65 (FIG. 33 e)) are the venting fabric 7, the top mould half 2, another venting fabric 7′, and the gas and resin impermeable vacuum sheet 59. This sheet is, just like the semipermeable foil, sealed all the way around towards the mould half 1. The ventilation space between the vacuum sheet 59 and the semipermeable foil 65 is evacuated via the vacuum connection 60, and the injection space between mould half 1 and the semipermeable foil 65 is evacuated via the vacuum connection 68.

As soon as, and only when, a vacuum is present at the connections 60 and 68, the hoses 8 may carefully be exposed to a higher gas pressure. This pressure must be dosed such that the semifinished fibre products 5′ and 5″ in the required overlap area 9′ and 9″ remain firmly joined together at all times and will not be separated, especially in the area of the reinforcements 20. If these conditions are fulfilled, the resin flow valve (not shown here) will be opened. This causes the resin to be sucked in and the distributor fabric will distribute it widely, so that the semifinished fibre products 5′ and 5″ will be evenly soaked by the effect of the vacuum and gravity.

In this process, first the laminate sections that are in contact will be permeated by the resin, i.e., the overlaps 9′ and 9″, and last the lower laminate sections provided for the design of the longitudinal and transversal reinforcements 20. The latest when the saturation with resin can be noticed by resin leaks, the resin flow will be stopped. This can be done automatically via suitable indicators, for example by resin leak indicators 71 (filling levels in transparent pipes, siphons, change in electrically detectable values by sensors, etc.). The evacuation is continued until the matrix has cured. For technical details, the German Patent 10 239 325 describing the so-called MT-RI method can be helpful. The difference of the present invention is mainly that mould hoses 8 are used to form reinforcements; furthermore also in this regard that the resin leak indicators shown in FIG. 33 e) are self-regulating. Additionally, the vacuum in the ventilation and injection space and thus the effectiveness of the gas evacuation from it can be maintained virtually undisturbed under resin leak.

FIG. 33 f) shows a mould structure that is fairly similar to the above. The difference is that now the mould half 2 made of solid material is missing. Its function is covered by the vacuum sheet 59 when a vacuum is generated.

In FIG. 33 g), the mould structure familiar from FIG. 33 e) is shown inverted after lamination, i.e., turned upside down. This causes the resin to flow in a different direction during the infiltration.

FIG. 34 shows another strut produced in accordance with the invention with rectangular profile and integrally incorporated fork-shaped connection brackets 11, shown in perspective representation (a) as well as in side view (b), top view (c) and front view (d).

FIG. 35 shows a strut produced in accordance with the invention with increasing diameter towards the middle, shown in perspective representation (a), side view (b), top view (c) and front view (d). Such struts designed to withstand high buckling loads are applied in aeronautics where they are used, among others, for the engineering of landing gear.

In order to level out assembly tolerances, struts are required that have an adjustable connection length. For most applications it is sufficient to design the brackets 11 with sufficient length and to fit bores 14 according to the connection length measured on site. Should this not be sufficient, adaptors are required. Existing technology has devices for length adjustment for numerous applications. FIGS. 36 to 40 show struts in accordance with the invention with a selection of such length adjustments.

FIG. 36 shows struts 10 with continuous adjustment, in particular also under load, by using turnbuckles consisting of clamping nuts 42, bolts with brackets 44′, 44″ and lock nuts 43′, 43″.

FIG. 37.1 displays another embodiment of a strut with continuous length adjustment and inner turnbuckle, in perspective representation (a), in top view (b) and in cross-sectional representation (c). The length adjustment of the strut is continuous, in particular also under load, without having to turn the brackets in the process. In order to install the turnbuckle, a strut produced in accordance with the invention is partitioned. Since any bending moments that may be caused by buckling loads would be highest in the middle of the strut, preferably a location towards the end of the strut will be chosen. Threaded bushings 40 and 41 are inserted into the cylindrical parts of each strut section and fixed, for example, by bonding. The left threaded bushing 40 has an inner left hand thread while the right threaded bushing 41 has an inner right hand thread. Both strut sections are connected via the adjustment bolt 42 with corresponding outer threads on each side. By turning the adjustment bolt, the whole strut will continuously increase or decrease in length due to the action of the two threads running in opposite direction, depending on in which direction the adjustment bolt 42 is turned. Once the strut has been adjusted to its required length, the lock nuts 43′ and 43″ prevent the adjustment bolt 42 from loosening.

FIG. 37.2 shows another strut with length adjustment by means of a turnbuckle. It is represented both in perspective (a) as well as in top view (b) and in cross-sectional representation (c). The threaded bushings 44′ and 44″ joined to the strut sections are now, contrary to those in FIG. 37.1, attached to the strut by an outer joint with positive fit. For this purpose they can already be included into the hollow mould during the strut's production process in accordance with the invention. By inflating the used hose or the balloon 8, the fibre ply encloses the end sections of the threaded bushings. After curing, this results in a positive fit between the threaded bushings 44′, 44″ and the outer surface of the strut. This joint with positive fit has the best ability to transmit compression and tension forces. Alternatively, the threaded bushings 44′ and 44″ can be, for example, glued onto the cured plastic.

The strut in FIG. 38, which is shown both in perspective (a) and in sectional (b) representation, achieves a stepwise adjustment of the connection element 34 in the slot hole 14 by shifting the small plates 35 along the plates 36 which are each toothed. The toothed plates 36 and the bracket 11 have a positive fit between each other. Therefore the connection element 34 can also be locked to the bracket with a positive fit. For this purpose, the connection element 34 is fitted with a bore in which a threaded pin 37 is inserted with accurate fit, which can slide up and down inside the slot hole 14. By means of the crown nut 39, the positive fit of the locked large toothed plates 36 and the sliding toothed plates 35 can be released, reinstated and secured. Hereby, the smallest adjustment width of the connection element 34 equals one tooth distance. The smaller the plates' teeth are designed, the smaller the length adjustment steps will be. This can only be done free of any load.

Further down, FIG. 39 shows a strut adjustable in length with a conically tapered end, shown in perspective representation (a) as well as in side view (b) and in sectional view (c). The length adjustment of the strut is done free of load via a fork-shaped connection with a threaded bolt 45 that can screw in and out of an insert 46 with a corresponding inner thread. The smallest possible adjustment length equals half a thread pitch. A lock nut 38 secures the connection. Tension forces are transmitted via the conic insert 46. Pressure forces are induced into the strut via the washer 39.

FIG. 40 shows a strut adjustable in length that is essentially similar to the strut described in FIG. 39. It is represented both in perspective (a) as well as in top view (b) and in sectional representation (c). The difference to the strut of FIG. 39 is how the end part is designed. In order to lock the insert 46, a section with increased thickness 52 is provided which is conically shaped to fit the insert 46. The length adjustment and the transmission of tension and pressure forces is done free of load as with the strut in FIG. 39.

FIG. 41 shows a blank of a seat beam produced in accordance with the invention, which can be used, for example, in aircraft seats.

FIG. 42 shows the cross-section of the blank of FIG. 41 with the components required for its production in accordance with the invention, such as the bottom mould half 1, the top mould half 2 and three inflatable hoses/balloons 8. It also illustrates how the fibre mats 5′ and 5″ are placed into the hollow mould halves and where they are overlapped.

FIG. 43 shows a cured, contour-machined blank for a seat beam similar to the blank in FIG. 41, with the difference that it contains an additional reinforcement in the form of an inner rib 21. Such a seat beam is already known from DE 10 2005 059 134 A1. The so-called single beam described there, however, consists of several glued individual components and not of a single unit such as the beam produced in accordance with the invention. The gluing of these individual components results in inaccuracies that are not occurring in a beam produced in accordance with the invention. Furthermore, in a beam produced in accordance with the invention all required connections can be integrated directly into the beam and implemented in the one shot method.

FIG. 44 shows the cross-section of the beam shown in FIG. 43. For integrating the inner rib 21 in accordance with the invention, two hoses or balloons 8 are required, where the two hoses/balloons are connected in communicating fashion in order to prevent any shifting of the rib bridges 21 during the manufacturing process.

FIG. 45 shows a design variation of the seat beam depicted in FIG. 41 produced in accordance with the invention.

FIG. 46 shows the upper mould half 2 for the production of the seat beam shown in FIG. 45 in accordance with the invention.

The corresponding bottom mould half 1 can be seen in FIG. 47. It consists of several individual parts in order to be able to extract the seat beam from the mould after curing.

FIG. 48 shows the open mould half 1. 4 blocks can be seen shortly before placing the laminate. Each block is lined with fibre mats (prepregs) in such a way that the transitions to the respective next block form a protruding section 6 (not shown but analogous to FIG. 9). After assembly of the individual blocks using threaded rods 53, the bottom mould half 1 is formed with the desired overlaps 9 (not shown). Into the mould laminated in this way a preformed balloon 8 is carefully inserted, then onto mould 1 the equally laminated top mould 2 is placed and firmly interlocked so that curing can take place in the usual way.

FIG. 49 shows the procedure of demoulding the seat beam 10 shown in FIG. 45 which is now cured inside the hollow mould (a). It should be noted beforehand that demoulding is not possible in a straight-forward procedure due to the existing undercuts. In order to facilitate this process in a simple way, the bottom mould half 1 is equipped with two additional elements; these are the spacers 55. These allow for demoulding as follows:

1. Separate the bottom mould half 1 from the top mould half 2
2. Undo and remove the threaded rods 53
3. Remove the top mould half 2 and the end pieces 51
4. Remove the spacers 55
5. Remove the remaining mould elements

FIG. 50 shows another design variation of the beam displayed in FIG. 45. The main difference is just the geometry of the three integrally incorporated brackets. This does not affect the production process.

FIG. 51 shows a seat base structure produced in accordance with the invention with integrally incorporated connection brackets.

FIG. 52 shows a carrier structure produced in accordance with the invention for an arm rest and FIG. 53 shows an arm rest structure produced in accordance with the invention with integrated connection brackets 11 for a swivelling pin.

FIG. 54 shows the components from FIGS. 50 to 53 produced in accordance with the invention in assembled configuration. The assembly of the individual components is done in each case via the integrally incorporated connection brackets 11 by means of screwing, bolting, riveting and/or gluing.

FIG. 55 shows a fork strut produced in accordance with the invention in perspective view (a), in top view (b) and in section along the partition plane. Such fork-shaped struts are used, for example, as so-called drag struts in extension/retraction mechanisms for the nose landing gear of aircraft.

FIG. 56 shows a cross-shaped strut arrangement crossed at right angles produced in accordance with the invention in perspective view (a) and in side view (b). Different strut arrangements other than at right angle are feasible. The field of application for such struts includes, for example, chassis or protective cage reinforcement in sports cars or stiffening fuselage segments in aircraft.

FIG. 57 shows a star-shaped hollow body produced in accordance with the invention featuring an integrally incorporated flange 11 in the centre. If during the production process only one balloon is used for pressing the laminate against the hollow mould halves, the result is a flange featuring a gap with separated laminates. By using a second balloon, the gap can be closed in order to obtain a solid flange after curing.

FIG. 58 (a) shows a sectional representation of the mould arrangement required for producing the hollow body shown in FIG. 57 using two balloons 8. The two hollow mould halves for this are shown in perspective representation in FIGS. 58 (b) and (c), respectively. FIG. 58 (d) shows a section through the mould structure for the in principal identical component using only one balloon. This results in a double connection with a gap, instead of one connection.

FIG. 59 shows another embodiment following the principle according to the invention, of a star-shaped hollow body with an integrally incorporated flange 11 in the centre. Against both flanges 11 a bearing bush (not shown) with front rest (using the bores 14) can be attached, while the front side (air approach direction) is generally fitted with a mushroom-shaped hub cap (not shown). Here (a) shows the isometric view, (b) the top view and (c) the side view of the hollow body. As can be seen in the side view (c), the partition plane of the hollow mould is perpendicular to the hub axis. Aerodynamically shaped hollow bodies of this kind can be used, for example, in aeronautics in the cold air flow section in front of the compressor of a gas turbine engine as bearing carrier for shafts with support against the inner wall of the turbine nacelle.

FIG. 60 shows in perspective representation (a), in top view (b) and in side view (c) the star-shaped hollow body known from FIG. 59, extended by the flanges 11 on the support arms 24. These also integrally incorporated flanges can be incorporated by methods that are illustrated in FIGS. 28 to 30.

Depending on the requirement, the outer flanges can be designed as large in azimuth that they touch each other or form a closed outer ring or an oval (spoke wheel or rim principle).

FIG. 61 shows a spoke wheel produced in accordance with the invention in perspective view (a), in side view (b) and in sectional representation (c). All that is required for the production, as shown in the section in FIG. 63, are two hollow mould halves. The partition plane between top and bottom mould runs more or less spherically through the centre of the wheel spokes. In FIG. 61 (b) its section (57) can be seen with the rim cylinder as dot and dash line.

FIG. 62 illustrates the basic design of the mould used for producing the spoke wheel shown in FIG. 61. According to the production method in accordance with the invention, as shown in FIG. 63, first the two mould halves 1 and 2 are laminated with semifinished fibre products 5′ and 5″ in such a way that protruding sections 6′ and 6″ (not shown) will form along the seam lines. The rings 26 and 27 are placed already while laminating the two mould halves 1, 2 into those and are overlapped or coated by fibre ply. These are intended for the precise formation of the rim 11, which will later hold the wheel tyre (not shown). Subsequently the two mould balloons 8 are inserted into the corresponding cavities of the mould halves. No laminate is applied onto the ring-shaped outer walls 28. The pressurised air ducts 29 are routed through the specific openings 25 (FIG. 62) from the top/bottom hollow mould half. Once the two fully prepared hollow moulds have been assembled, they are firmly joined, for example, by bolts, which are inserted through the ring-shaped mould walls 28. Then pressurised air and thus pressure can be applied in order to press the laminate layers into the hollow mould to exact dimensions and complete curing in the usual way.

FIG. 63 shows the assembled mould from FIG. 62 in cross-section.

FIGS. 64, 66 and 67 show hollow bodies closed on one side that are produced in accordance with the invention, in perspective representation (a) and in side view (b), which essentially share the same characteristics. Unlike FIG. 64, the hollow bodies in FIGS. 66 and 67 are equipped with additional reinforcing ribs. The hollow body in FIG. 66 is reinforced by an inner rib 21. In FIG. 67 a rib bridge 20 is integrated as reinforcement for the hollow body. All hollow bodies in FIGS. 64 to 67 are once again produced according to the principle in accordance with the invention illustrated in FIGS. 6 to 9 and feature integrally incorporated elements 11 in the connection area. They are used, for example, as base elements for control flaps in aeronautics and can be designed accordingly and ceramised, if required.

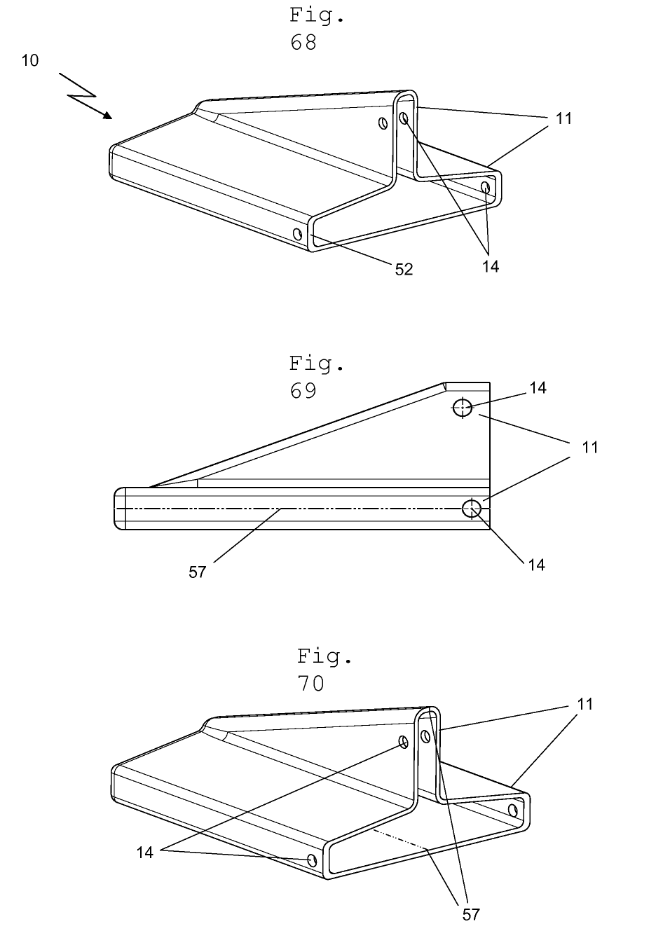

FIGS. 68 to 70 show more design variations of the above described base elements for control flaps. They differ in the position of the relevant partition plane 57 of the hollow mould used for their production. From the outside the produced fibre composite products are geometrically identical. In FIG. 69 a horizontal and in FIG. 70 a vertical mould partition is indicated via the partition lines 57. These specific control flaps can thus be manufactured with hollow moulds of different partition designs and as such have different pros and cons that to a large degree are determined by the different lamination in each case.

The control flap shown in FIG. 71 can only be demoulded if the partition plane 57 of the used mould runs horizontally. The brackets or connection areas 11 are integrated in accordance with the invention and fitted with bores 14.

FIG. 72 shows two other, geometrically equal embodiments of a control flap produced in accordance with the invention with a horizontal (a) and with a vertical (b) partition plane 57. The connection areas 11 are fully integrated “brackets”, whose edges can be contour-machined. The holes 14 are drilled after curing.

FIGS. 73 to 75 illustrate one of several mechanisms for retracting and extending a control flap 30. The displayed mount 32 should be seen here as part of the fix structure of a re-entry vehicle, where the control flap 10 pivots around its axle 63. The control flap 10 responds to pressure or tension from the control rod 31. The control flaps in FIGS. 64, 66 and 67 are lacking integrally incorporated elements 11 for the mounting pin 63 of the control rod 31 (FIGS. 73 to 75). In order to actuate such control flaps, superstructures are required that can be attached to those with ceramic screws for example. For relatively small control flaps 10 it is possible to have their pivoting movements performed by actuators that apply, for example, via worm gear, directly onto the pivot axle 63 situated along the plane of the mount 32.

FIG. 76 shows a blade produced in accordance with the invention with an integrated flange in isometric view (a) and in side view (b). Such blades can be used, for example, for wind power plants.

Another field of application of the production method for fibre-reinforced hollow bodies in accordance with the invention are brake discs. FIG. 77 shows an example of such a brake disc. Its side walls 58 act as friction surfaces. While driving, the brake disc is exposed to air flows both from inside and outside which cool the walls 58 and inner ribs 21. The disc is designed in such a way that it will withstand high mechanical and thermal loads which occur during braking. In order to ensure low abrasion, the structure has coatings of ceramic, sintered metal or similar materials. When inorganic fibres of, for example, silicon carbide are used for the brake disc blank, an abrasion-resistant SiC/SiC ceramic brake disc with very high thermo-mechanical qualities can be generated by multiple pyrolysis and infiltration of SiC. It is relatively costly to produce due to the extensive work involved and is initially intended preferably for top class vehicles and sports cars. Both production variants have advantages compared to the current state of the art, such as, for example, lower weight and thus a reduction of the inert translatory and rotational masses on the vehicle.

FIG. 78 (a) to (f) show a sequence of the production process for the brake disc shown in FIG. 77. First the laminate 5′ or 5″ is placed into the bottom or top hollow mould 1 and 2, respectively. Subsequently, the laminates for the rib bridges 21 are placed in such a way next to each other into the bottom hollow mould 1 that they support each other and form a complete circle. In order to minimise the time involved, the individual U-shaped laminates are preformed accordingly. The rib laminates 21 can also be placed before or after the inflatable element 8 is inserted into the hollow mould 1. The protrusions 6 of the rip bridges 21 are bent over the relevant side arm of the mould balloon 8. Before firmly locking the two hollow mould halves, the pressurised air duct 29 is routed through the opening 49 from the top hollow mould 2. By pressurising the mould balloon 8, the individual fibre plies are pressed in such a way against the inner walls of the hollow mould or against adjacent fibre mats that in cured condition they will form a perfect unit to exact dimensions with excellent strength characteristics. During the last stage, minor finishing will be performed on the cured brake disc and the flange 11 is fitted with bores 14. Instead of U-shaped, the rib laminates can also be tailored in L-shape so that only one protrusion 6 in each case would have to be bent.

The production method in accordance with the invention can also be applied with all its characteristics to the air intake front lip of an aircraft gas turbine for example, as illustrated in FIGS. 79 to 83. The only essential difference to the manufacturing of the straight seat beam as in FIGS. 41 and 42 is the more or less torus-shaped geometry required for this method. As in the seat beam, also the intake front lip has integrally incorporated attachment elements 11. In FIG. 79 the jet engine front lip is shown in perspective representation from the front (a), in perspective representation from the back (b) and in sectional representation (c). FIG. 80 shows a bottom mould half 1 suitable for the production and already lined with semifinished fibre products 5′ in perspective (a) and in sectional representation (b). The upper mould half 2 equally lined with fibre mats 5″ can be seen in FIG. 81. FIG. 82 shows this upper mould half 2 with inserted balloons 8 in sectional representation.

Overall three balloons or hoses 8 are required for producing the air intake front lip as in FIG. 83. In order to be able to remove the hose or balloon 8 enclosed by laminate from the cured unit, a suitable removal opening 49 is provided already during placement of the fibre mats. Prior to removal, the hose or balloon 8 is cut into pieces. The pressurised air ducts 29 are routed to the inflatable hoses or balloons 8 via two bores 25 in the upper mould half 2, as can be seen in FIGS. 82 and 83. In FIG. 83 the laminated mould halves 1 and 2 are placed on top of each other and shown in sectional representation.

FIG. 84 shows an alternative for producing the air intake front lip. With this method, the two lateral balloons 8 push the laminate layers 5′ and 5″ against the top mould half not from the inside but from the outside. Depending on whether a higher precision is required from the inner or the outer surface, a suitably designed mould can be used as in FIGS. 83 and 84.

FIG. 85 shows a panel which forms, for example, the outer shell of an aircraft and is fitted with integrated longitudinal and transversal bracing 20 which are also referred to as stringer and rib 20. This panel can be produced with and according to all characteristics of the invention.

FIG. 86 shows the bottom mould half 1 for producing such an outer shell panel with the grooves 20′ for stringer and rib. In FIGS. 87 to 92, the detail marked in FIG. 86 can be seen in subsequent manufacturing stages. The applicable production processes essentially correspond to those already illustrated in FIGS. 32 and 33. The only significant differences are the curved instead of planar geometry of the outer shell panel, and the fact that ribs have a larger cross-section than stringers, which means that also the mould hoses or mould balloons 8 must be adapted accordingly. The process starts in familiar fashion with the lining of the bottom mould half 1, by placing the venting fabric 7, tear-off foil 66, semifinished fibre products 5′, as shown in FIG. 33. The formation of stringers (longitudinal bracing) 20 and/or ribs (transversal bracing) 20 is ensured by suitable different grooves in the bottom hollow mould half FIG. 88. These are created with the first lamination stage. In the next stage, mould hoses with side arms 8, similar to FIG. 32d, are placed into the laminated rib and stringer grooves 20′ of mould 1. Parallel to that, the top mould half 2 is coated with semifinished fibre product 5″ and placed with the laminate side facing down, as in FIGS. 90 and 91, onto the mould half 1 and pressed against it with the effect of pressure forces 62. Usually this is achieved by using the surrounding air pressure, by enveloping the mould structure, for example, with a vacuum jacket 59, as shown in FIG. 33, and evacuating it. This pressurises the hoses or balloons 8 so that at increased temperature in the oven the laminate layers bond and the prepreg resin cures. In this way the outer shell panel is created. In accordance with the invention, it is a compound of stringers and ribs 20 onto which elements 11—here in particular the outer shell—are integrally incorporated. Additionally, in general connections are incorporated.

Instead of prepreg, also pre-treated dry semifinished fibre product 5 preformed by means of a positive or negative mould can be used, which must be soaked with liquid resin after placement of the laminate layer 5′ onto the mould half 1 and after insertion of the hoses 8 into the grooves 20′ and placement of the laminate layer 5″. The required mould structure corresponds to the one in FIG. 33 e) and f). The laminate layer 5″ is covered by a tear-off foil 65 and a gas-permeable and resin-impermeable foil 66. The essential difference of the present method to the German Patent 10 239 325, the so-called MT-RI method, is that additional mould hoses 8 are used. These allow producing significantly more complex units with increased dimensional accuracy and product quality in the one shot process.

FIG. 92 shows an outer shell panel produced in accordance with the invention with integrated connections 11. These connections are designed in such a way that the outer shell panels can be connected with each other by riveting, bolting/screwing and/or gluing, as shown in FIG. 93.

FIG. 94 shows a floor crossbeam produced in accordance with the invention with integrally incorporated connections.

FIG. 95 illustrates a fuselage segment assembled from 8 outer shell panels produced in accordance with the invention. Additional connections on two panels allow the attachment of other structural components, such as, for example, the floor crossbeam shown in FIG. 94.

FIG. 96 shows an outer shell panel produced in accordance with the invention with an opening for a passenger door and an integrated reinforcement frame around the opening. In similar way, such frames are also used around openings of cargo gates, windows, etc., in particular in aircraft and vehicles (magnetic levitation trains, high-speed trains, buses, etc.).

For rail vehicles used in high-speed applications it is required to replace high-mass components by light units. FIG. 97 shows a bogie made of fibre composite produced with the method in accordance with the invention. The required mould halves mostly match those presented for the production of panel segments in FIGS. 32, 33, 86 to 89.

FIG. 98 shows a train wheel for high speeds. The wheel rim is made of metal, also the bearing bush inserted into the hub. The hub is integrally incorporated into the disc-shaped fibre-reinforced wheel body with rim. The production is done, as can be seen from the mould structure, according to the procedure in terms of the invention.

### Production of a Ceramic Hollow Body

As matrix material, a synthetic resin on epoxy resin base is provided, which is common for prepregs. However, other resins such as vinyl ester resins for example can also be used. These, however, have a shorter time span for processing at room temperature.

For the production of a fibre-reinforced hollow body according to the method in terms of the invention, two hollow mould halves, such as those shown in FIG. 6 for example, are required, whereas each has a negative recess, i.e., a trough, that for struts with brackets roughly corresponds to the one in FIG. 6 b). This represents a longitudinal section through one hollow mould half. The conically tapered or wedge-shaped transitions to the end bracket areas can be seen clearly. FIG. 7 to 9 illustrate mould halves for a cylindrical strut including the process sequence.

Into the mould halves, prepregs are placed according to the load specification with an optimised fibre alignment for each section. FIG. 10 shows an example for a possible layer structure of the prepregs. In the transition and bracket section, unidirectional reinforcement fibres are placed in axial direction with increased percentage. Fibre layers that are woven crosswise can be mixed in between in layers.

Before two mould halves lined with prepreg layers are joined by placing them onto each other, a hose or balloon, for example made of silicone material, is placed into one of the mould halves onto the fibre layers, which are equipped with venting fabric or not. This hose is inflated once the two mould halves are firmly locked, for example, by bolting them together, and once one of the hose ends is clamped off. By inflating it, the hose, and thus the semifinished fibre product (prepreg) is pressed firmly against the inner wall of the hollow mould under pressure and free of any creases, acquiring the desired hollow body shape.

In order to align the protruding edge strips 6, which are protruding from the negative recesses by a pre-defined level, free of any creases, the invention provides shoulders 3, 4 made of steel for example (FIG. 7 and FIG. 8). Their stop surfaces 18 may be coated in order to have an effect on the adhesion of the prepreg strips. Furthermore, the shoulders 3, 4 may be equipped with horizontally movable rails 19, for example with L-profile (FIG. 11) that act as stop surfaces 18 during laminating and during the positioning (shifting) of protruding edge strips 6. This facilitates a crease-free handling of the edge strips 6 protruding from the mould halves 1, 2 until their final positioning shortly before the two mould halves 1, 2 are placed on top of each other. As soon as the inserted hose or balloon 8 is pressurised, its expansion promotes the pre-defined overlapping of the protruding edge strips 6 towards each other and/or with the semifinished fibre product 5 placed into the negative mould earlier. The same applies for all areas, also at the ends of the hollow mould. Curing the matrix under moderate heat at specific polymerisation temperature of the used resin system ensures that the fibre-reinforced hollow body 10 is fixed permanently. The curing is followed by a mechanical finishing process, for example, contour-machining the brackets and drilling the bracket holes.

When fibre-reinforced hollow bodies 10 are produced for high and low temperature applications, the existing matrix can now be converted by pyrolysis and infiltration. Under the effect of heat and in the absence of oxygen, a ceramic hollow body with increased porosity is created. In order to largely close the pores, the matrix is densified by means of infiltration. Using wet methods, the pyrolysed hollow body is dipped into a bath of liquid matrix and after a specific time the infiltrated hollow body is removed and pyrolysed once again. This process can be repeated several times. This decreases the porosity and increases the density.

With dry methods such as CVI (Chemical Vapour Infiltration) and CVD (Chemical Vapour Deposition) a very similar effect with increased quality can be achieved. The ceramic hollow body (for example of SiC/SiC) densified in this way can be used in a wide temperature range, in particular at very low as well as very high temperatures, for example as heat-resistant lance for taking samples of molten metal, as cinder removal tool, as strut for control flaps on re-entry vehicles, as cold and heat-resistant component for structures in aerospace industry, etc.

Field of Application for Fibre-Reinforced Hollow Bodies Produced in Accordance with the Invention

Struts are used to transmit forces onto components that, directly or with regard to force deflection without struts, are difficult to bring into contact with the carrying structure. Fibre-reinforced hollow bodies such as, for example, tubes with brackets or lateral fins, can withstand huge thermo-mechanic loads, in particular when they are made of fibre-reinforced ceramic materials (CMC).

Due to the weight, stiffness and strength benefits compared to metal designs, fibre-reinforced plastic hollow bodies, in particular carbon fibre-reinforced plastic struts, are used preferentially in the aerospace industry. Apart from sports equipment (racing bicycles, sports cars), they are currently not as widely used in vehicle engineering as they could be. The reason for that is that so far they have been relatively costly.

Other possible fields of application, should the cost go down, would be in modern construction business, in general in light scaffolding, support and tower construction, crane engineering, booms and extension arms, for example for solar trough support frames or solar panels, both on Earth and in space, wind power installations, roof structures with translucent design such as, for example, sport facilities and stadiums, solar updraft power plants and similar lightweight constructions designed for large surfaces that are exposed to high loads.

Fireproof fibre-reinforced hollow bodies can be exposed to both very low and very high temperatures. As such they are used in the aerospace industry, specifically for re-entry vehicles, for example as struts for control flaps or as control flaps and similar structures themselves. Fibre-reinforced ceramic tubes with lateral integrated brackets and/or fins can be exposed to extreme temperature differences and simultaneously to high mechanical loads. They can be used, for example, in refrigeration and heat engineering, in steam generator and reactor construction, including applications in high-temperature solar technology.

As previously mentioned, the essential process steps for producing a fibre-reinforced hollow body in accordance with the invention can be seen in FIGS. 7 to 10.

According to that, the shoulders 3 and 4 are attached onto the two hollow mould halves open towards the top (negative moulds) 1 and 2, and the semifinished fibre products 5 impregnated with a resin-hardener mix (prepreg) are placed into the negative moulds 1 and 2 layer by layer with edge protrusions 6, thus laminated. Then venting fabric 7 is placed, if required, onto the fibre layers 5. Subsequently, an inflatable hose 8, for example, is inserted into the hollow mould halves 1, then the hollow mould half 2 is placed onto the hollow mould half 1 and bolted close to form a sealed unit. Parallel to that, one end of the hose 8 is clamped off, unless instead of the hose 8 a “hose” with closed end similar to an elongated balloon is used. Thereafter, the hose 8 is pressurised displacing the air trapped between the hose and the semifinished fibre products (prepregs), and the resin is cured under controlled conditions with regards to inner hose pressure and temperature in the oven. If required, any residual air pockets and developing gas can be sucked out of the hollow mould and thus the fibre layers by means of vacuum technology via a channel system (not shown).

Once the matrix is cured, the pressurised air/gas is released from the hose or balloon, the joined hollow mould halves are separated and the hose is pulled from the extracted fibre-reinforced plastic hollow body including any present venting fabric 7. The hose or balloon can be accessed via the hollow ends (brackets). Thereafter, the brackets are finished by mechanical processing means, in particular contour-machined, and fitted with bores.

If the fibre-reinforced hollow body will be applied in ceramic consistency, the now existing cured matrix should be converted as described above.

The production method in accordance with the invention applies for any fibre type, any type of fabric and any matrix material (resin type). The resin may be a thermoplast or duroplast. Both pre-impregnated semifinished fibre products, so-called prepregs, and soaked fibre material can be used. The curing temperature depends on the used prepreg or resin system, also the pressure applied.

When dry semifinished fibre composite products are used for producing hollow bodies, the problem arises that the fibre plies may shift after placement into the mould half. In order to prevent this, a pre-treatment of the dry semifinished fibre composite products is required, which is known as the so-called preforming. With this method, a thermoplastic or duroplastic binding agent is added to the individual fibre layers, which are then placed onto a positive core. In order to fix the layers into place they are covered with a sheet, and with a sealant they are sealed towards the edge of the positive or negative mould to prevent any incorporation of air. By evacuating the air from underneath the foil, the surrounding air pressure presses the individual fibre layers firmly onto the positive core. By subsequently inducing heat, the binding agent is activated, penetrating the dry fibre ply and subsequently curing. The fibre composite produced in this way will be treated as dry semifinished fibre product during further processing, that means it will be soaked with resin inside the negative mould and the resin matrix will be cured under heat and pressure.

The hose is made of a rubber-like, flexible material, preferably silicone or Teflon. In mass production, instead of the hose, hoses (balloons) with closed end and a nozzle can be used that resemble inflatable elongated (children's) balloons. Also hoses with end nozzles can be used, where, for example, one end can be clamped shut and the other connected to the pressurised air/gas pipe. For complex hollow bodies, it may be necessary to use custom-made tailored mould hoses or mould balloons.

Trapped air and gases can be released or evacuated (by means of vacuum technology) from the closed hollow mould via the venting fabric or a channel system (not shown).

Due to the open design, unidirectional reinforcement fibres can be placed ideally in longitudinal direction of the negative recesses into each of the two mould halves (FIG. 7 and FIG. 8). The semifinished fibre products will adhere to the inner walls of the negative recesses due to their permeation with resin or tack. No creases will form during placement as well as while and after they are pressed against the inner walls by means of the pressurised hose. As a result of the opportunity to place reinforcement fibres at specific locations according to specification, extremely light hollow bodies with very high strength and stiffness with connection brackets and similar elements can be produced at economic conditions. Especially the specific placement of the reinforcement fibres in the highly stressed load bearing area of the brackets allows a surprisingly high bearing stress load.

By inflating the hose, air is expelled from the closed hollow mould. Venting fabrics that are placed onto the inner fibre layers can support the expelling of the air to an advantageous extent. Simultaneously the fibre layers are compressed. Any existing air pockets will mostly be pressed out of the hollow mould. If required, even the entire hollow mould can be evacuated. This depends on the specific requirements and the resin system.

Of particular benefit is the fact that the hollow body can be cured in one shot (one shot curing). There is no subsequent need to glue fibre-reinforced plastic components together. In this way, fibre-reinforced hollow bodies with brackets or similar incorporated elements can be produced as integral units.

As previously mentioned, apart from tubular or oval-shaped hollow bodies, the method in accordance with the invention also allows for the production of open hollow bodies that have an even bottom and diagonal or vertical edges or side walls. Any brackets, for example in form of one or two outer fins or inner ribs, can be firmly joined with the bottom or the side walls. An applied example are pot-shaped or box-shaped hollow bodies with bridge walls as brackets. The bottom may have any shape, preferably it is circular or rectangular. The shaping is done as previously by using semifinished fibre products that are placed generally in several layers into the bottom mould half according to the load. Furthermore, also here a hose or balloon is used, which presses the fibre material into the recesses of the negative mould as soon as the bottom mould half is closed by the top mould half and the hose is inflated with air. For complex shapes, several hoses or balloons can be used that are interconnected in communication fashion for even pressure distribution.

The curing of the resin binding the fibres is done in the oven under controlled pressure and temperature conditions. It required, the closed mould can be placed into a sealed jacket and evacuated inside the oven. Once cured, the near net shape fibre-reinforced plastic hollow body with integrated brackets, ribs, bridge walls, etc., can be contour-machined and finished.

For high and low temperature applications, the matrix must be converted by means of pyrolysis and subsequent densified by any of the known methods. One example for the application of a box-shaped fibre-reinforced open CMC hollow body thus produced is the control flap on a re-entry vehicle. The structural design can be similar to the one in FIG. 2 of EP 0 941 926 B1, but does not have to, since that design consists of many small segments which according to the present invention can be united to larger segments in near net shape. Also a one-piece CMC control flap seems to be feasible with the present method in accordance with the invention.

Already with the first tests where prepreg carbon fibres were used for producing plastic hollow bodies, especially struts with integrated brackets, it could be proven that the obtained laminate quality is more than compliant with the requirement standards of the aerospace industry, i.e., the pore content of the strut material was below 1% and the fibre volume content at approx. 60%. Due to the novel structural design, the reject quote was reduced to virtually zero.

1-24. (canceled)

25. Method for the production of fibre-reinforced fault-free components (10) consisting of a hollow body (12) and at least one load-bearing solid subcomponent (11), where fibre mats (5) for all component areas (11, 12, 13), especially for the transition and end sections (13, II), are placed according to the load in direction of the force flow and laminated into two halves (1, 2) of a hollow mould, which each form the negative mould for the fibre-reinforced component (10) to be produced, and laminating them in such a way that after the two halves (1, 2) of the hollow mould thus lined are joined, the fibre mats (5) are pressed into the hollow mould with positive fit by means of pressure so that the hollow body (12) and the at least one load-bearing solid subcomponent (11) are incorporated into each other in monolithic or integral fashion.

26. Method according to claim 25, characterised in that the fibre mats (5) for the load-bearing end section (11) are placed in isotropic fashion.

27. Method according to claim 25, characterised in that the fibre mats (5) are fibre plies soaked with resin.

28. Method according to claim 25, characterised in that the fibre mats (5) are fibre prepregs.

29. Method according to claim 25, characterised in that the fibre mats (5) are essentially dry fibre plies, which, equipped with thermoplastic or duroplastic binding agents, have been preformed by means of preforming using a positive or negative mould respectively.

30. Method according to claim 25, characterised in that the fibre mats (5) are pressed into the hollow mould with positive fit by means of an inflatable element (8) inserted into the hollow mould, which is achieved by inflating the inflatable element (8) after the two halves (1, 2) of the hollow mould have been joined.

31. Method according to claim 25, characterised in that the fibre mats (5) are placed into the halves (1, 2) of the hollow mould according to a defined load specificity of various sections (11, 12, 13) of the component (10).

32. Method according to claim 25, characterised in that onto the fibre mats (5) additionally a venting fabric (7) is placed.

33. Method according to claim 25, characterised in that the fibre mats (5) and, if applicable, the venting fabric (7) are placed into one half (1, 2) each of the hollow mould in such a way that they protrude by a specific level over at least one upper edge of the relevant hollow mould half (1, 2).

34. Method according to claim 33, characterised in that the protruding sections (6) of the fibre mats (5) and, if applicable, the venting fabric (7) prior to joining the hollow mould halves (1, 2) are fanned out in such a way that the fanned out sections are fitting into each other once the halves are joined.

35. Method according to claim 33, characterized in that for the formation of the material sections (6) protruding above the upper edge of the hollow mould halves (1, 2), shoulders (3, 4) are positioned next to the hollow mould halves (1, 2) at least on one side, which will support the protruding material sections (6) during lamination.

36. Method according to claim 35, characterised in that additionally metal rails (19, 19′) are positioned next to the shoulders (3, 4).

37. Method according to claim 36, characterised in that the fibre ply present in the hollow mould is evacuated, if required, and additionally infiltrated with resin, if necessary.

38. Method according to claim 37, characterised in that the fibre ply present in the hollow mould is exposed to a pressure and temperature treatment.

39. Method according to claim 25, characterized in that the hollow body blank obtained in this way is subject to a mechanical finishing process.

40. Method according to claim 25, characterized in that the hollow body blank obtained in this way is subject to a pyrolysis and chemical densification.

41. Method according to claim 25, characterized in that the fibres in the inserted fibre mats are aligned in unidirectional, crossed, multiaxial and/or crosswise fashion.

42. Method according to claim 25, characterized in that the fibres are fixed and aligned in a thermoplastic matrix material.

43. Method according to claim 25, characterized in that the fibres are fixed and aligned in a duroplastic matrix material.

44. Method according to claim 25, characterized in that the fibres used for fibre reinforcement are selected from carbon, glass, aramid, polyester, polyethylene and nylon fibres.

45. Method according to claim 25, characterized in that the used fibres are selected from inorganic fibres, if a chemically densified hollow body should be created.

46. Method according to claim 44, characterised in that the fibres are selected from carbon, silicon carbide, aluminium oxide, mullite, boron, wolfram, boron carbide, boron nitride and zirconium fibres.

47. Method according to claim 43, characterised in that same-sort or mixed-sort fibres are used.

48. Method according to claim 25, characterized in that the hollow mould halves (1, 2) for producing fibre-reinforced hollow bodies (10) are designed with cylindrical, oval, square or rectangular cross-section with or without inner ribs (21).

49. Method according to claim 25, characterized in that the hollow mould halves (1, 2) are designed for the production of fibre-reinforced components such as tubes with flanges, finned tubes, reinforced plate segments, seat segments, fork struts for aircraft nose landing gear, spoke bodies, spoke wheels, or (CMC) control flaps, blades for wind turbines, brake discs, air intake front lips of aircraft gas turbines, outer shell segments of means of transport, bogies for wagons or train wheels, in particular of struts and beams.

50. Fibre-reinforced fault-free components (10) consisting of a hollow body (12) and at least one load-bearing solid subcomponent (11), produced by placing fibre mats (5) for all component areas (11, 12, 13), especially for the transition and end sections (13, II), according to the load in direction of the force flow into two halves (1, 2) of a hollow mould, which each form the negative mould for the fibre-reinforced component (10) to be produced, and laminating them in such a way that after the two halves (1, 2) of the hollow mould thus lined are joined, the fibre mats (5) are pressed into the hollow mould with positive fit by means of pressure so that the hollow body (12) and the at least one load-bearing solid subcomponent (11) are incorporated into each other in monolithic or integral fashion.

51. Component according to claim 49, characterised in that the fibre mats (5) for the load-bearing end section (11) are placed in isotropic fashion.

52. Component according to claim 49, characterised in that the fibre mats (5) are fibre plies soaked with resin.

53. Component according to claim 49, characterised in that the fibre mats (5) are fibre prepregs.

54. Component according to claim 49, characterised in that the fibre mats (5) are essentially dry fibre plies, which, equipped with thermoplastic or duroplastic binding agents, have been preformed by means of preforming using a positive or negative mould respectively.

55. Component according to claim 49, characterised in that the fibre mats (5) are pressed into the hollow mould with positive fit by means of an inflatable element (8) inserted into the hollow mould, which is achieved by inflating the inflatable element (8) after the halves (1, 2) of the hollow mould have been joined.

56. Component according to claim 49, characterised in that the fibre mats (5) are placed into the halves (1, 2) of the hollow mould according to a defined load specificity of various sections (11, 12, 13) of the component (10).

57. Component according to claim 49, characterised in that onto the fibre mats (5) additionally a venting fabric (7) is placed.

58. Component according to claim 49, characterised in that the fibre mats (5) and, if applicable, the venting fabric (7) are placed into one half (1, 2) each of the hollow mould in such a way that they protrude by a specific level over at least one upper edge of the relevant hollow mould half (1, 2).

59. Component according to claim 58, characterised in that the protruding sections (6) of the fibre mats (5) and, if applicable, of the venting fabric (7) prior to joining the hollow mould halves (1, 2) are fanned out in such a way that the fanned out sections are fitting into each other once the halves are joined.

60. Component according to claim 58, characterised in that for the formation of the material sections (6) protruding above the upper edge of the hollow mould halves (1, 2), shoulders (3, 4) are positioned next to the hollow mould halves (1, 2) at least on one side, which will support the protruding material sections (6) during lamination.

61. Component according to claim 60, characterised in that additionally metal rails (19, 19′) are positioned next to the shoulders (3, 4).

62. Component according to claim 61, characterised in that the fibre ply present in the hollow mould is evacuated, if required, and additionally infiltrated with resin, if necessary.

63. Component according to claim 62, characterised in that the fibre ply present in the hollow mould is exposed to a pressure and temperature treatment.

64. Component according to claim 49, characterised in that the hollow body blank obtained in this way is subject to a mechanical finishing process.

65. Component according to claim 49, characterised in that the hollow body blank obtained in this way is subject to a pyrolysis and chemical densification.

66. Component according to claim 49, characterised in that the fibres in the inserted fibre mats are aligned in unidirectional, crossed, multiaxial and/or crosswise fashion.

67. Component according to claim 49, characterised in that the fibres are fixed and aligned in a thermoplastic matrix material.

68. Component according to claim 49, characterised in that the fibres are fixed and aligned in a duroplastic matrix material.

69. Component according to claim 49, characterised in that the fibres used for fibre reinforcement are selected from carbon, glass, aramid, polyester, polyethylene and nylon fibres.

70. Component according to claim 49, characterised in that the used fibres are selected from inorganic fibres, if a chemically densified hollow body should be created.

71. Component according to claim 70, characterised in that the fibres are selected from carbon, silicon carbide, aluminium oxide, mullite, boron, wolfram, boron carbide, boron nitride and zirconium fibres.

72. Component according to claim 67, characterised in that same-sort or mixed-sort fibres are used.

73. Component according to claim 25, characterised in that the hollow mould halves (1, 2) for producing fibre-reinforced hollow bodies (10) are designed with cylindrical, oval, square or rectangular cross-section with or without inner ribs (21).

74. Component according to claims 73, in the form of tubes with flanges, finned tubes, reinforced plate segments, seat segments, fork struts for air craft nose landing gear, spoke bodies, spoke wheels, or (CMC) control flaps, blades for wind turbines, brake discs, air intake front lips of aircraft gas turbines, outers hell segments of means of transport, bogies for wagons or train wheels, in particular of struts and beams.
